(19) United States
(12) Patent Application Publication
(10) Pub. No.: US 2026/0322902 A1
(43) Pub. Date: Oct. 15, 2026

(54) ROTATING SHAFT STRUCTURE AND FOLDABLE TERMINAL

(71) Applicant: Honor Device Co., Ltd., Shenzhen (CN)

(72) Inventors: Shuai Su, Shenzhen (CN); Ruihao Chen, Shenzhen (CN); Changfu Dong, Shenzhen (CN); Shaohong Dong, Shenzhen (CN); Jian Huang, Shenzhen (CN)

(21) Appl. No.: 19/104,538

(22) PCT Filed: Nov. 17, 2023
(86) PCT No.: PCT/CN2023/132197

§ 371 Date: Feb. 18, 2025

(30) Foreign Application Priority Data
Feb. 16, 2023 (CN) 202310165524.5

(51) Int. Cl. H04M 1/02

(52) U.S. Cl. CPC H04M 1/022; H04M 1/0268

(57) ABSTRACT

Embodiments of this application provide a rotating shaft structure and a foldable terminal. The rotating shaft structure is applied to an outward foldable terminal. The outward foldable terminal includes a first body, a second body, and the rotating shaft structure connecting the first body to the second body. The rotating shaft structure includes: a shaft cover; two connecting members, located on two sides of the shaft cover, and configured to respectively connect to the first body and the second body; a rotating mechanism, rotatably connected to the shaft cover and slidably and rotatably connected to the connecting members, and configured to control movements of the connecting members; a synchronization mechanism, rotatably connected to the shaft cover and slidably and rotatably connected to the connecting members, and configured to synchronize rotation of the two connecting members; and a plurality of damping mechanisms.

### CROSS-REFERENCED TO RELATED APPLICATIONS

This application is a national stage of International Application No. PCT/CN 2023/132197, filed on Nov. 17, 2023, which claims priority to Chinese Patent Application No. 202310165524.5, filed on Feb. 16, 2023. The disclosures of both of the aforementioned applications are hereby incorporated by reference in their entireties.

### TECHNICAL FIELD

This application relates to the field of electronic device technologies, and in particular, to a rotating shaft structure and a foldable terminal.

### BACKGROUND

With constant development of display technologies, foldable terminals (for example, foldable mobile phones) gradually become a future development trend of mobile electronic products. The foldable terminals can have a larger display area in an unfolded state, improving a visual effect, and can have a smaller volume in a folded state, facilitating carrying by users, and therefore, are increasingly favored by more users.

A structure for implementing folding and unfolding of a foldable terminal is a rotating shaft structure. The rotating shaft structure includes a damping mechanism, a synchronization mechanism, and the like. In a folding and unfolding process of the foldable terminal, the damping mechanism provides a damping force, achieving a folding and unfolding feel. However, an existing damping mechanism has problems such as a small damping force and a poor folding and unfolding feel.

### SUMMARY

To resolve the foregoing technical problem, this application provides a rotating shaft structure and a foldable terminal, to increase a damping force of the rotating shaft structure and achieve a folding and unfolding feel. The structure is simple, and the costs are low.

According to a first aspect, an embodiment of this application provides a rotating shaft structure. The rotating shaft structure is applied to an outward foldable terminal. The outward foldable terminal includes a first body, a second body, and the rotating shaft structure connecting the first body to the second body. The rotating shaft structure includes: a shaft cover; two connecting members, located on two sides of the shaft cover, and configured to respectively connect to the first body and the second body; a rotating mechanism, rotatably connected to the shaft cover and slidably and rotatably connected to the connecting members, and configured to control movements of the connecting members; a synchronization mechanism, rotatably connected to the shaft cover and slidably and rotatably connected to the connecting members, and configured to synchronize rotation of the two connecting members; and a plurality of damping mechanisms, where the plurality of damping mechanisms include a concave-convex gear damping mechanism and/or a smoothing damping mechanism. The concave-convex gear damping mechanism includes a pin shaft, a concave gear, a first spring, and at least two damping swing arms, the pin shaft is fixedly connected to the shaft cover, and the concave gear and the first spring are both sleeved on the pin shaft; the damping swing arm includes a rotating cam sleeved on the pin shaft and neighboring to and in contact with the concave gear and a swinging member located on a side of the rotating cam, and the swinging members of the two damping swing arms are slidably and rotatably connected to the two connecting members; and when the swinging members and the connecting members are slided and rotated, the first spring is compressed and generates an axial squeezing force, applied between the concave gear and the rotating cam to generate a damping force. The smoothing damping mechanism includes two smoothing members, the smoothing member includes a smoothing swing arm and a flexible unit, the flexible units of the two smoothing members are respectively fastened to the two connecting members, ends of the smoothing swing arms are rotatably connected to the shaft cover, and other ends of the smoothing swing arms of the two smoothing members are respectively slidably and rotatably connected to the connecting members; the flexible unit includes a connecting rod and a flexible beam, and the smoothing swing arm is fixedly connected to the connecting rod; and when the other end of the smoothing swing arm and the connecting member are slided and rotated, the connecting rod is driven to move, and the flexible beam is compressed to generate a damping force.

The plurality of damping mechanisms in the outward foldable terminal include the concave-convex gear damping mechanism and/or the smoothing damping mechanism, so that a damping force of the damping mechanisms can be increased. In addition, the damping mechanisms not only can provide a flattening force, but also can provide a closing force to adjust a folding and unfolding feel of the rotating shaft structure, helping improve user experience. Moreover, when the plurality of damping mechanisms are a plurality of concave-convex gear damping mechanisms, a problem of severer abrasion caused by a larger pressure of a cam surface of a single damping mechanism can be avoided. When the plurality of damping mechanisms include the smoothing damping mechanism, it helps maintain a hovering, unfolded, or folded state of the rotating shaft structure. Furthermore, the damping mechanism has a simple structure and low costs.

In some possible implementations, the plurality of damping mechanisms further include a lateral damping mechanism; and the lateral damping mechanism includes two lateral members, the lateral member includes a lateral swing arm and a lateral rotating portion, the lateral rotating portion is rotatably connected to the shaft cover, and the lateral swing arms of the two lateral members are respectively slidably connected to the two connecting members; and the lateral swing arm is provided with a support member and a roller rotatably connected to the support member, at least one second spring is sleeved on the support member, two opposite ends of the second spring are respectively fixedly connected to the support member and the roller; and when an angle of a plane on which the two connecting members are located is within a preset angle range, the roller is in contact with a side wall of the shaft cover, the shaft cover squeezes the roller, and the second spring is compressed to generate a damping force.

By disposing the lateral damping mechanism, when the rotating shaft structure is in an unfolded state, an unfolding retention force of the rotating shaft structure is improved by using an acting force between the roller and the shaft cover, helping improve user experience. In addition, the concave-convex gear damping mechanism and/or the smoothing damping mechanism further improves the folding and unfolding feel.

For example, the preset angle range may be, for example, 90° to 180°, 120° to 180°, or 150° to 180°.

In some possible implementations, the rotating mechanism includes a main swing arm group, and the main swing arm group includes two main swing arms separately disposed on two sides of the shaft cover; and the main swing arm includes a first main swing member and a second main swing member that are fixedly connected, the connecting member is provided with a first connecting sliding groove adapted to the second main swing member, the main swing arm is rotatably connected to the connecting member by using the second main swing member, the shaft cover is provided with a first shaft cover sliding groove adapted to the first main swing member, the main swing arm is rotatably connected to the shaft cover by using the first main swing member, a position of the shaft cover remains unchanged, the first main swing members of the two main swing arms in the main swing arm group are rotated relative to the shaft cover to drive, by using the second main swing members of the two main swing arms in the main swing arm group, the two connecting members to rotate.

The main swing arm provided in this application has a simple structure, a preparation difficulty is reduced, and costs are relatively low.

In some possible implementations, on a basis that the main swing arm includes the first main swing member and the second main swing member that are fixedly connected, cross-sectional shapes of the first main swing member and the second main swing member are both arc-shaped, improving bending reliability of the entire terminal.

In some possible implementations, the rotating mechanism further includes a secondary swing arm group, the secondary swing arm group includes two secondary swing arms separately disposed on two sides of the shaft cover, the secondary swing arm includes a swing arm rotating member and a sliding member, the swing arm rotating member is fastened to a side wall of the sliding member, the sliding member is provided with a first protrusion, and at least one swing arm sliding groove is formed between the first protrusion and the sliding member; and the connecting member is provided with a second connecting sliding groove adapted to the sliding member, a first protruding strip adapted to the swing arm sliding groove is formed on a side wall of the second connecting sliding groove, the secondary swing arm is slidably connected to the connecting member by using the swing arm sliding groove, the shaft cover is provided with a second shaft cover sliding groove adapted to the swing arm rotating member, the secondary swing arm is rotatably connected to the shaft cover by using the swing arm rotating member, a position of the shaft cover remains unchanged, the swing arm rotating members of the two secondary swing arms in the secondary swing arm group are rotated relative to the shaft cover to drive, by using the sliding members of the two secondary swing arms in the secondary swing arm group, the two connecting members to rotate.

The secondary swing arm provided in this application has a simple structure, a preparation difficulty is reduced, and costs are relatively low.

In some possible implementations, the synchronization mechanism includes two synchronization members, the synchronization member includes a synchronization swing arm and a gear, the gears of the two synchronization members mesh with each other, and the synchronization swing arms of the two synchronization members are separately disposed on two sides of the two gears meshing with each other; the gear is rotatably connected to the shaft cover by using a gear shaft, two side walls of an end of the synchronization swing arm far away from the gear is provided with a first protruding post; and the connecting member is provided with a third connecting sliding groove adapted to the synchronization swing arm, a side wall of the third connecting sliding groove is partially recessed to form a first groove adapted to the first protruding post, and the first protruding post is slided and rotated in the first groove, so that the synchronization mechanism is slidably and rotatably connected to the connecting member.

The synchronization mechanism provided in this application has a simple structure, a preparation difficulty reduced, costs are relatively low, and synchronization reliability during bending of the entire terminal is ensured.

In some possible implementations, the foldable terminal further includes a flexible screen, located on a side of the first body, the rotating shaft structure, and the second body; and the rotating shaft structure further includes a support door panel, fixedly connected to the rotating mechanism and rotating with rotation of the rotating mechanism, and the support door panel is configured to support the flexible screen.

A connection manner of the support door panel is simple. In addition, by supporting the flexible screen by the support door panel, a screen stress is reduced, preventing a bending region of the flexible screen from collapsing, falling, or being damaged.

In some possible implementations, on a basis that the rotating shaft structure further includes the support door panel, when the main swing arm includes the first main swing member and the second main swing member, the first main swing member and the second main swing member each are provided with a fastening post, and the main swing arm is connected to the support door panel by using the fastening posts. The fastening posts can implement a connection of the support door panel, a fastening manner is simple, and another structure does not need to be changed, helping dispose the another structure.

In some possible implementations, on a basis that the rotating shaft structure further includes the support door panel, a material of the support door panel includes an ultra-high polymer material, and the support door panel is integrally formed.

This arrangement improves machining reliability and reduces machining costs of the support door panel, and the formed support door panel is relatively flat, improving a carrying capability of the support door panel for the flexible screen, and ameliorating a problem such as a screen crease.

In some possible implementations, the rotating shaft structure further includes a decorating door panel, fixedly connected to the rotating mechanism and rotating with rotation of the rotating mechanism, and the decorating door panel is configured to cover the rotating mechanism, the synchronization mechanism, and/or the damping mechanism to protect the rotating mechanism, the synchronization mechanism, and/or the damping mechanism, and prevent the rotating mechanism, the synchronization mechanism, and/or the damping mechanism from interfering with another structure in the terminal.

In some possible implementations, on a basis that the rotating shaft structure further includes the decorating door panel, when the secondary swing arm includes the swing arm rotating member and the sliding member, the decorating door panel is fixedly connected to a side of the sliding member facing away from the first protrusion, so that the decorating door panel is fixedly connected to the secondary swing arm; and two opposite ends of the decorating door panel are partially bent, a decorating sliding groove is formed between a bent portion of the decorating door panel and an unbent portion of the decorating door panel, two opposite ends of the connecting member each are provided with a second protrusion, the second protrusion is located in the decorating sliding groove, and the decorating door panel is slidably connected to the connecting member through the decorating sliding groove. The secondary swing arm can implement a connection of the decorating door panel, a fastening manner is simple, and another structure does not need to be changed, helping dispose the another structure.

In some possible implementations, on a basis that the rotating shaft structure further includes the decorating door panel, a material of the decorating door panel includes an ultra-high polymer material, and the decorating door panel is integrally formed.

This arrangement improves machining reliability and reduces machining costs of the decorating door panel, and the formed decorating door panel is relatively flat. When the rotating shaft structure is disposed in the foldable terminal, it facilitates disposing of another structure in the terminal.

In some possible implementations, there are two pin shafts, two concave gears, two first springs, and four damping swing arms; the two pin shafts are arranged side by side along a first direction, the pin shaft extends along a second direction, the concave gear has two concave gear holes, the two concave gear holes are arranged side by side along the first direction, the concave gear is separately sleeved on the two pin shafts through the two concave gear holes, there is a gap between the two concave gears, the two first springs are respectively sleeved on the two pin shafts and are separately located in the gap between the two concave gears, the rotating cams of the two damping swing arms are disposed neighboring to one of the concave gears and are located on a side of the concave gear facing away from the first spring along the second direction, and the rotating cams of other two damping swing arms are disposed neighboring to the other concave gear and are located on a side of the concave gear facing away from the first spring along the second direction; two side walls of an end of the swinging member far away from the rotating cam are provided with a second protruding post, the connecting member is provided with a fifth connecting sliding groove adapted to the damping swing arm, a side wall of the fifth connecting sliding groove is partially recessed to form a second groove adapted to the second protruding post, and the second protruding post is slided and rotated in the second groove, so that the damping mechanism is slidably and rotatably connected to the connecting member; the first direction is a direction from the first body to the second body, and the second direction is an axial direction of the rotating shaft structure.

The damping mechanism provided in this application has a simple structure, a preparation difficulty is reduced, costs are relatively low, and a provided damping force is relatively large.

For example, the first direction is an X-axis direction in an embodiment, and the second direction is a Y-axis direction in an embodiment.

In some possible implementations, on a basis that there are two pin shafts, two concave gears, two first springs, and four damping swing arms, a connection portion is disposed between two damping swing arms located on the same pin shaft, and two ends of the connection portion are respectively fixedly connected to the two damping swing arms, to ensure synchronization of the two damping swing arms located on the same pin shaft, and ensure reliability during bending of the entire terminal.

In some possible implementations, the smoothing swing arm includes a rotating shaft and a sliding portion located on a side of the rotating shaft, the sliding portion is provided with a limiting block, and two side walls of an end of the sliding portion far away from the rotating shaft each are provided with a third protruding post; the flexible beams are located on two sides of the connecting rod, and the connecting rod is provided with a limiting hole; the shaft cover is provided with a rotating hole adapted to the rotating shaft, so that the smoothing swing arm is rotatably connected to the shaft cover; and the connecting member is provided with a fourth connecting sliding groove, a side wall of the fourth connecting sliding groove is partially recessed to form a third groove adapted to the third protruding post, and the third protruding post is slided and rotated in the third groove, so that the smoothing swing arm is slidably and rotatably connected to the connecting member; and the flexible beams located on the two sides of the connecting rod are separately fastened to an unrecessed side wall of the fourth connecting sliding groove, and the limiting block of the smoothing swing arm is clamped in the limiting hole of the connecting rod, so that the smoothing swing arm is fixedly connected to the connecting rod.

The damping mechanism provided in this application has a simple structure, a preparation difficulty is reduced, costs are relatively low, and a provided damping force is relatively large.

In some possible implementations, when the plurality of damping mechanisms further includes the lateral damping mechanism, two side walls of the lateral swing arm each are provided with a second protruding strip, the connecting member is provided with a fifth connecting sliding groove, a side wall of the fifth connecting sliding groove is partially recessed to form a fourth groove adapted to the second protruding strips, and the second protruding strips are slided in the fourth groove, so that the lateral swing arm is slidably connected to the connecting member; the shaft cover is provided with a third shaft cover sliding groove adapted to the lateral rotating portion, and the lateral member is rotatably connected to the shaft cover by using the lateral rotating portion; there are two lateral rotating portions, the two lateral rotating portions are spaced away; the lateral swing arm is an annular structure with an opening, and the two lateral rotating portions are separately fixedly connected to the lateral swing arm and are located on two sides of the opening; and the support member is located in the annular structure, and the roller is located in a gap between the two lateral rotating portions.

The damping mechanism provided in this application has a simple structure, a preparation difficulty is reduced, costs are relatively low, and a provided damping force is relatively large.

In some possible implementations, there are three damping mechanisms. When there are three damping mechanisms, the costs do not increase due to an increase in the quantity of damping mechanisms, and the folding and unfolding feel is not affected due to a reduced damping force caused by an extremely small quantity of damping mechanisms.

In some possible implementations, the three damping mechanisms are all concave-convex gear damping mechanisms; or the three damping mechanisms are all smoothing damping mechanisms; or at least one of the three damping mechanisms is a concave-convex gear damping mechanism, and at least one of the three damping mechanisms is a smoothing damping mechanism. Certainly, a combination manner of the three damping mechanisms is not limited thereto.

In some possible implementations, there are three damping mechanisms; and at least one of the three damping mechanisms is a concave-convex gear damping mechanism, and at least one of the three damping mechanisms is a lateral damping mechanism; or at least one of the three damping mechanisms is a smoothing damping mechanism, and at least one of the three damping mechanisms is a lateral damping mechanism. Certainly, a combination manner of the three damping mechanisms is not limited thereto.

According to a second aspect, an embodiment of this application provides a foldable terminal. The foldable terminal is an outward foldable terminal. The outward foldable terminal includes the rotating shaft structure according to the first aspect. Beneficial effects are the same as those of the first aspect.

### BRIEF DESCRIPTION OF THE DRAWINGS

FIG. 1 is a diagram of a structure of a foldable terminal according to an embodiment of this application;

FIG. 2 is a diagram of a foldable mobile phone during folding according to an embodiment of this application;

FIG. 3 is a diagram of a front surface structure of a rotating shaft structure according to an embodiment of this application;

FIG. 4 is a diagram of a back surface structure of a rotating shaft structure according to an embodiment of this application;

FIG. 5 is an exploded view of the rotating shaft structure shown in FIG. 3;

FIG. 6 is an exploded view of the rotating shaft structure shown in FIG. 4;

FIG. 7 is a diagram of a structure of a main swing arm according to an embodiment of this application;

FIG. 8 is a diagram of a partial structure of a connecting member according to an embodiment of this application;

FIG. 9 is a diagram of a position relationship of a main swing arm, a connecting member, and a shaft cover according to an embodiment of this application;

FIG. 10 is a diagram of a structure of a secondary swing arm group according to an embodiment of this application;

FIG. 11 is a diagram of a partial structure of a connecting member according to an embodiment of this application;

FIG. 12 is a diagram of a structure of a synchronization mechanism according to an embodiment of this application;

FIG. 13 is a diagram of a partial structure of a connecting member according to an embodiment of this application;

FIG. 14 is a top view of a damping mechanism according to an embodiment of this application;

FIG. 15 is a three-dimensional view of a damping mechanism according to an embodiment of this application;

FIG. 16 is a diagram of a partial structure of a connecting member according to an embodiment of this application;

FIG. 17 is an enlarged view of a region QQ in FIG. 3;

FIG. 18 is a cross-sectional view of FIG. 17 along a direction OO';

FIG. 19 is a diagram of a partial structure of a rotating shaft structure according to an embodiment of this application;

FIG. 20 is a diagram of a position relationship of a support door panel when a foldable terminal is in a folded state according to an embodiment of this application;

FIG. 21 is a diagram of a partial structure of a rotating shaft structure according to an embodiment of this application;

FIG. 22 is a section view of FIG. 21 along a direction PP';

FIG. 23 is a diagram of a partial structure of a connecting member according to an embodiment of this application;

FIG. 24 is a diagram of a partial structure of a decorating door panel according to an embodiment of this application;

FIG. 25 is a diagram of a front surface structure of another rotating shaft structure according to an embodiment of this application;

FIG. 26 is a diagram of a back surface structure of another rotating shaft structure according to an embodiment of this application;

FIG. 27 is an exploded view of the rotating shaft structure shown in FIG. 25;

FIG. 28 is an exploded view of the rotating shaft structure shown in FIG. 26;

FIG. 29 is an enlarged view of a region WW in FIG. 25;

FIG. 30 is an enlarged view of a region RR in FIG. 27;

FIG. 31 is a cross-sectional view of FIG. 29 along a direction SS';

FIG. 32 is a diagram of a front surface structure of another rotating shaft structure according to an embodiment of this application;

FIG. 33 is a diagram of a back surface structure of another rotating shaft structure according to an embodiment of this application;

FIG. 34 is an exploded view of the rotating shaft structure shown in FIG. 32;

FIG. 35 is an exploded view of the rotating shaft structure shown in FIG. 33;

FIG. 36 is a partial diagram of a position relationship of a second damping mechanism and a shaft cover according to an embodiment of this application;

FIG. 37 is a cross-sectional view of FIG. 36 along a direction TT';

FIG. 38 is a top view of a second damping mechanism according to an embodiment of this application; and

FIG. 39 is a three-dimensional view of a second damping mechanism according to an embodiment of this application.

### REFERENCE NUMERALS

10—first display unit; 20—first body; 30—second body; 40—rotating shaft structure; 100—foldable mobile phone;

21—first housing; 22—first middle frame; 221—first exterior part;

31—second housing; 32—second middle frame; 321—second exterior part;

41—shaft cover; 411—first shaft cover sliding groove;

42—rotating mechanism; 421—main swing arm; 4211—first main swing member; 4212—second main swing member; 4213—fastening post; 422—secondary swing arm; 4221—swing arm rotating member; 4222—sliding member; 42221—first sliding surface; 42222—second sliding surface; 42223—side sliding surface; 4223—first protrusion; 42231—first protruding portion; 42232—second protruding portion; 4224—swing arm sliding groove; 423—connecting member; 4230—connecting hole; 4231—first connecting member; 4232—second connecting member; 4233—first connecting sliding groove; 4234—second connecting sliding groove; 4235—first protruding strip; 4236—structural member; 4237—third connecting sliding groove; 4238—first groove; 4239—fifth connecting sliding groove; 4240—second groove; 4241—second protrusion; 4242—fourth connecting sliding groove; 4243—third groove;

43—synchronization mechanism; 431—synchronization member; 4311—synchronization swing arm; 43111—first protruding post; 4312—gear; 43121—gear portion; 43122—gear rotating portion;

44—damping mechanism; 44a—first damping mechanism; 44b—second damping mechanism; 44b1—first smoothing member; 44b2—second smoothing member; 44b3—first lateral member; 44b3—second lateral member; 44c—third damping mechanism; 441—pin shaft; 442—concave gear; 4421—concave gear hole; 443—spring; 444—damping swing arm; 4441—rotary annular cam; 4442—swinging member; 4443—second protruding post; 445—connection portion; 446—smoothing swing arm; 4461—rotating shaft; 4462—sliding portion; 4463—limiting block; 4464—third protruding post; 447—flexible unit; 4471—connecting rod; 44711—limiting hole; 4472—flexible beam; 448—lateral swing arm; 4481—second protruding strip; 4482—opening; 4483—end portion; 4484—support member; 4485—roller; 449—lateral rotating portion; 4486—second spring; 4487—bottom surface;

45—support door panel; 451—first support door panel; 452—second support door panel;

46—decorating door panel; 461—first decorating door panel; 462—second decorating door panel; and 463—decorating sliding groove.

### DETAILED DESCRIPTION OF ILLUSTRATIVE EMBODIMENTS

The following clearly and completely describes technical solutions in embodiments of this application with reference to the accompanying drawings in the embodiments of this application. Obviously, the described embodiments are a part rather than all of embodiments of this application. All other embodiments obtained by a person of ordinary skill in the art based on embodiments of this application without creative efforts shall fall within the protection scope of this application.

The term “and/or” in this specification describes only an association relationship between associated objects and represents that three relationships may exist. For example, A and/or B may represent the following three cases: Only A exists, both A and B exist, and only B exists.

In the specification and claims of embodiments of this application, the terms such as “first” and “second” are used to distinguish between different objects, but are not intended to describe a particular order of the objects. For example, a first target object, a second target object, and the like are used to distinguish between different target objects, but are not intended to describe a particular order of the target objects.

In embodiment of this applications, the term such as “example” or “for example” represents giving an example, an illustration, or a description. Any embodiment or design scheme described as an “example” or “for example” in embodiments of this application should not be explained as being more preferred or having more advantages than another embodiment or design scheme. Exactly, use of the word “example”, “for example”, or the like is intended to present a related concept in a specific manner.

In the descriptions of embodiments of this application, unless otherwise stated, “a plurality of” means two or more than two. For example, a plurality of processing units are two or more processing units, and a plurality of systems are two or more systems.

An embodiment of this application provides a foldable terminal. The foldable terminal provided in this embodiment of this application may be a mobile phone, a tablet computer, a personal digital assistant (personal digital assistant, PDA for short), an in-vehicle computer, a television, a smart wearable device, a smart home device, or the like. A specific form of the foldable terminal is not particularly limited in this embodiment of this application. For ease of description, an example in which the foldable terminal is a foldable mobile phone is used below.

FIG. 1 is a diagram of a structure of a foldable terminal according to an embodiment of this application. As shown in FIG. 1, a foldable mobile phone 100 includes a first display unit (also referred to as a foldable screen or a flexible screen) 10.

The first display unit 10 is, for example, a flexible display screen. The first display unit 10 is, for example, an organic light emitting diode (Organic Light Emitting Diode, OLED) display screen. The OLED display screen does not need a back light unit, and a base substrate in the OLED display screen may use, for example, a flexible resin material such as polyethylene terephthalate (Polyethylene terephthalate, PET), so that the OLED display screen has a bendable feature. Certainly, a type of the first display unit 10 includes but is not limited to the OLED display screen, and all bendable display screen shall fall within the protection scope of this application. For example, the first display unit 10 may alternatively be a liquid crystal display (Liquid Crystal Display, LCD) screen, an LED display screen (for example, a micro-LED display screen or a mini-LED display screen), or the like.

It should be noted that to clearly describe subsequent structure features and a position relationship of the structure features, a position relationship of structures in the foldable mobile phone 100 are defined based on an X-axis direction, a Y-axis direction, and a Z-axis direction. The X-axis direction is a width direction after the foldable mobile phone 100 is unfolded. The Y-axis direction is a length direction after the foldable mobile phone 100 is unfolded. The Z-axis direction is a thickness direction after the foldable mobile phone 100 is unfolded.

Still refer to FIG. 1. The foldable mobile phone 100 further includes a structural component. The structural component includes a first body 20, a second body 30, and a rotating shaft structure 40. Along the X-axis direction, the first body 20 and the second body 30 are located on two sides of the rotating shaft structure 40. The rotating shaft structure 40 is separately connected to the first body 20 and the second body 30. The first body 20, the rotating shaft structure 40, and the second body 30 may be configured to carry the first display unit 10. The first body 20 and the second body 30 may be separated rotated around an axis So (parallel to the Y-axis direction) of the rotating shaft structure 40 to implement a folding state, an unfolding state, or the like of the first display unit 10, that is, to implement a folding state, an unfolding state, or the like of the foldable mobile phone 100.

It should be noted that the foldable mobile phone 100 may be folded at a plurality of positions. Correspondingly, the structural component may include a plurality of rotating shaft structures 40 and a plurality of bodies. For example, the structural component may include two rotating shaft structures 40 and three bodies, and two neighboring bodies are connected by using one rotating shaft structure 40. In this way, the foldable mobile phone 100 has two folding positions. As can be learned, the structural component includes at least one rotating shaft structure 40 and at least two bodies, and two neighboring bodies are connected by using one rotating shaft structure 40. For ease of description, embodiments of this application are all described by using an example in which the structural component includes one rotating shaft structure 40 and two bodies (namely, the first body 20 and the second body 30).

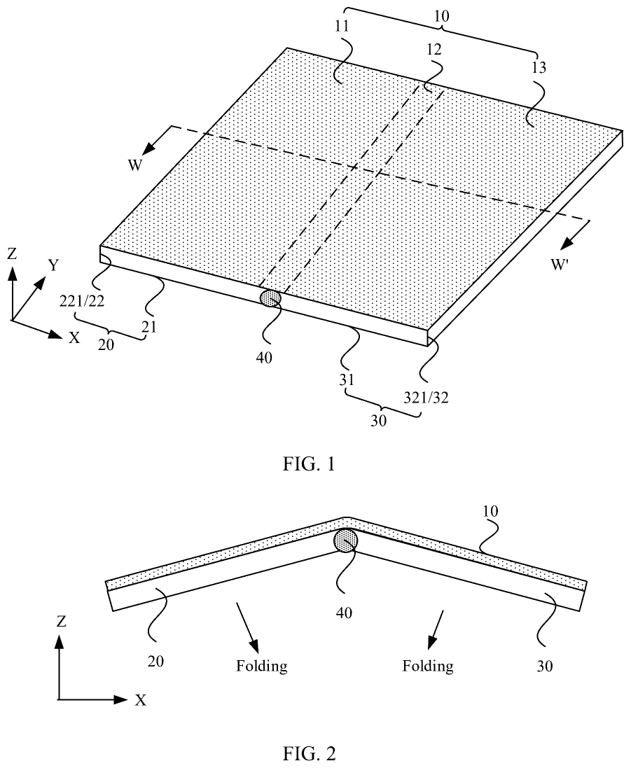

FIG. 1 is a diagram of a foldable mobile phone after unfolding. FIG. 2 is a diagram of a foldable mobile phone during folding In FIG. 2, when folded, the foldable mobile phone 100 may be folded towards directions facing away from light-emitting directions (indicated by arrows in FIG. 2) of the first display unit 10, that is, directions in which the first body 20 and the second body 30 are rotated around the rotating shaft structure 40 are opposite to the light-emitting directions of the flexible screen 10, in other words, when the foldable mobile phone 100 is in a folded state, the first display unit 10 is exposed to the outside. In this case, the foldable mobile phone 100 may also be referred to as an outward foldable mobile phone.

Still refer to FIG. 1. The first body 20 includes a first housing 21 and a first middle frame 22. The second body 30 includes a second housing 31 and a second middle frame 32.

The first housing 21 may be a back cover (also referred to as a battery cover) of the foldable mobile phone 100, or may be a display unit used for display. This is not limited in this embodiment of this application. The second housing 31 may be a back cover (also referred to as a battery cover) of the foldable mobile phone, or may be a display unit used for display. This is not limited in this embodiment of this application either. Embodiments of this application are all described by using an example in which the first housing 21 is a back cover and the second housing 31 is a display unit (also referred to as a second display unit or a display screen, to be distinguished from the first display unit 10).

A type of the second display unit 31 includes, for example, a display screen such as an LCD display screen, an OLED display screen, or an LED display screen.

Still refer to FIG. 1. The first middle frame 22 includes a first exterior part 221 and a first support member (not shown in FIG. 1) that is located between the first display unit 10 and the back cover 21. The second middle frame 32 includes a second exterior part 321 and a second support member (not shown in FIG. 1) that is located between the first display unit 10 and the second housing 31.

The first display unit 10, the back cover 21, the first exterior part 221, the second display unit 31, and the second exterior part 321 form an accommodating chamber. The accommodating chamber is provided with a structure such as a printed circuit board, a flexible printed circuit, or a functional device (not shown in FIG. 1 and FIG. 2). The functional device includes, for example, a display driver module, a camera, and a battery. The first support member of the first middle frame 22 and the second support member of the second middle frame 32 support a structure in the accommodating chamber.

The rotating shaft structure 40 includes a shaft cover, a rotating structure, a synchronization mechanism, a damping mechanism, a door panel, and the like. However, each structure in an existing rotating shaft structure 40 has a relatively large quantity of parts, and machining complexity and costs are high. In addition, an existing damping mechanism has problems such as a small damping force and a poor folding and unfolding feel.

Based thereupon, an embodiment of this application provides a rotating shaft structure. The rotating shaft structure has a small quantity of parts and is easy to assemble, a weight of the entire terminal is reduced, costs are reduced, and a damping force of the rotating shaft structure is increased to implement a folding and unfolding feel. In addition, a problem such as a screen crease can further be ameliorated.

A specific structure of the rotating shaft structure provided in this embodiment of this application is described below.

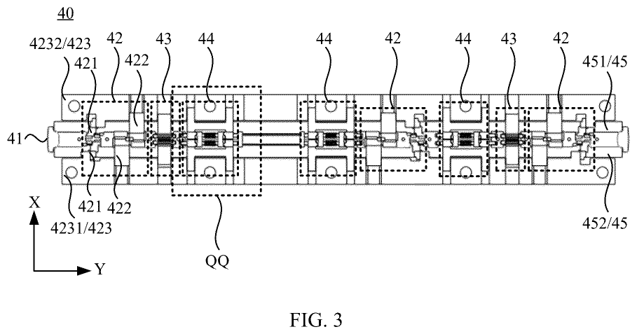

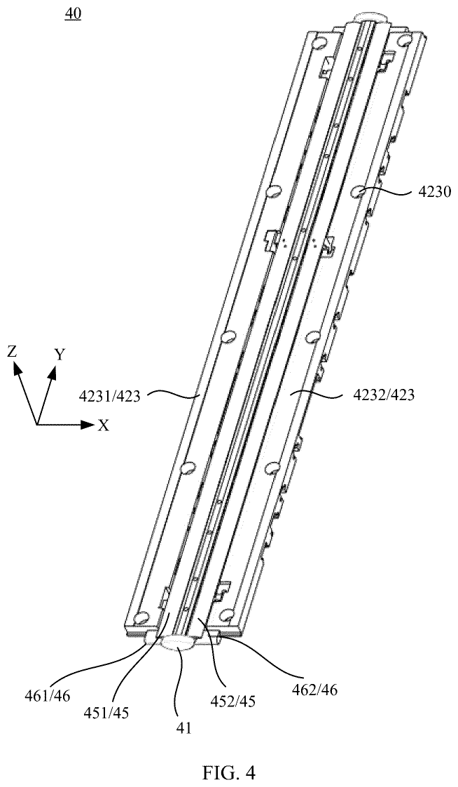

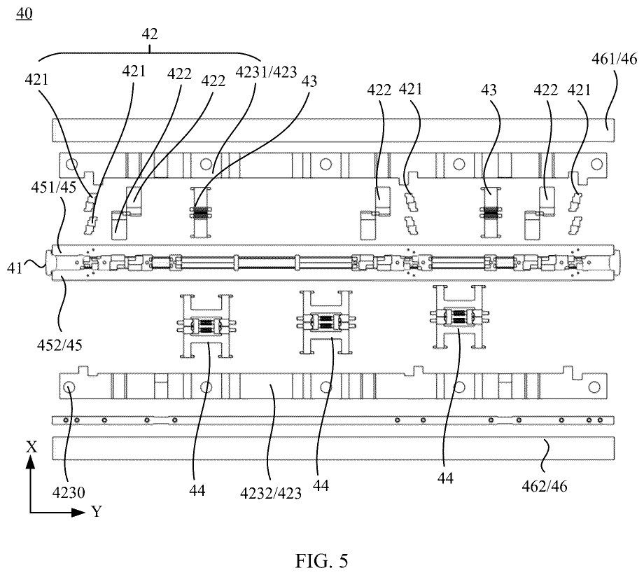

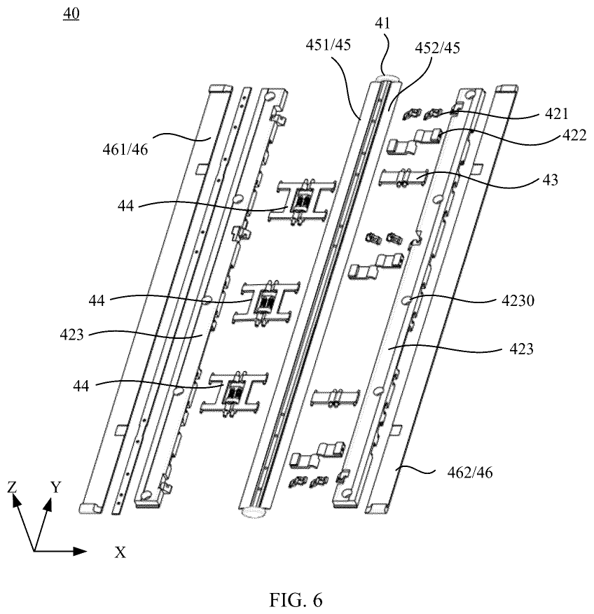

In an example, FIG. 3 is a diagram of a front surface structure of a rotating shaft structure according to an embodiment of this application; FIG. 4 is a diagram of a back surface structure of a rotating shaft structure according to an embodiment of this application; FIG. 5 is an exploded view of the rotating shaft structure shown in FIG. 3; and FIG. 6 is an exploded view of the rotating shaft structure shown in FIG. 4. As shown in FIG. 3, FIG. 4, FIG. 5, and FIG. 6, the rotating shaft structure 40 includes a shaft cover 41, a rotating mechanism 42, a synchronization mechanism 43, a damping mechanism 44, two support door panels 45, and two decorating door panels 46. The two support door panels 45 are a first support door panel 451 and a second support door panel 452. The two decorating door panels 46 are a first decorating door panel 461 and a second decorating door panel 462. Along the X-axis direction, the first support door panel 451 and the second support door panel 452 are separately disposed on two sides of the shaft cover 41. The first decorating door panel 461 and the second decorating door panel 462 are separately disposed on two sides of the shaft cover 41.

It should be noted that to clearly display structures such as the shaft cover 41, the rotating mechanism 42, the synchronization mechanism 43, and the damping mechanism 44 of the rotating shaft structure 40, FIG. 3 does not show the decorating door panel 46 (which covers the shaft cover 41, the rotating mechanism 42, the synchronization mechanism 43, and the damping mechanism 44).

The rotating mechanism 42 includes a main swing arm group and a secondary swing arm group. The main swing arm group includes two main swing arms 421 separately disposed on two sides of the shaft cover 41 along the X-axis direction. The secondary swing arm group includes two secondary swing arms 422 separately disposed on two sides of the shaft cover 41 along the X-axis direction. For example, there are a plurality of main swing arm groups and a plurality of secondary swing arm groups. The plurality of main swing arm groups and the plurality of secondary swing arm groups are evenly disposed on the shaft cover 41 separately.

For example, there are three main swing arm groups and three secondary swing arm groups, which are evenly disposed on the shaft cover 41 separately.

The rotating shaft structure 40 further includes two connecting members 423 separately disposed on two sides of the shaft cover 41 along the X-axis direction. The two connecting members 423 are a first connecting member 4231 and a second connecting member 4232. The first connecting member 4231 and the second connecting member 4232 each are provided with at least one connecting hole 4230. The first connecting member 4231 is fixedly connected to the first body 20 through the connecting hole 4230 on the first connecting member 4231. For example, the first connecting member 4231 is fixedly connected to the first support member of the first middle frame 22 through the connecting hole 4230 on the first connecting member 4231 to fixedly connect to the first body 20. The second connecting member 4232 is fixedly connected to the second body 30 through the connecting hole 4230 on the second connecting member 4232. For example, the second connecting member 4232 is fixedly connected to the first support member of the second middle frame 32 through the connecting hole 4230 on the second connecting member 4232 to fixedly connect to the second body 30.

That is, the rotating shaft structure 40 is connected to the first body 20 and the second body 30 by using the two connecting members 423 to fold or unfold the first body 20 and the second body 30 by using the rotating shaft structure 40.

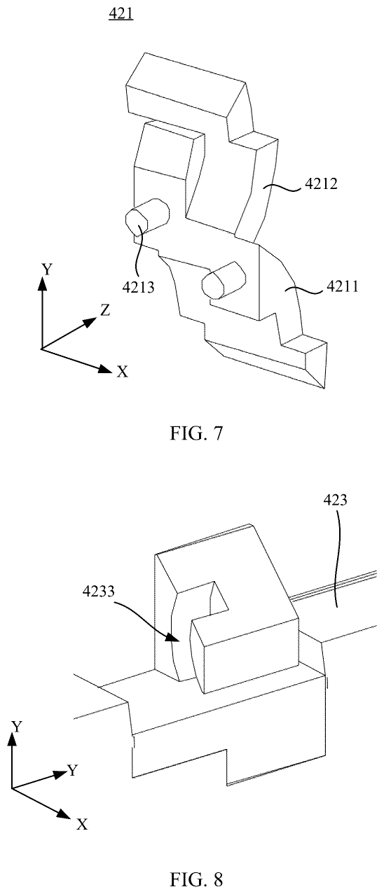

FIG. 7 is a diagram of a structure of a main swing arm according to an embodiment of this application; FIG. 8 is a diagram of a partial structure of a connecting member according to an embodiment of this application; and FIG. 9 is a diagram of a position relationship of a main swing arm, a connecting member, and a shaft cover. As shown in FIG. 7, FIG. 8, and FIG. 9, the main swing arm 421 includes a first main swing member 4211 and a second main swing member 4212. Cross-sectional shapes of the first main swing member 4211 and the second main swing member 4212 are both arc-shaped or approximately arc-shaped, that is, projections of the first main swing member 4211 and the second main swing member 4212 on a plane formed by the X-axis and the Z-axis are both arc-shaped or approximately arc-shaped. The connecting member 423 is provided with a first connecting sliding groove 4233 adapted to the second main swing member 4212. At least a part of the second main swing member 4212 is located in the first connecting sliding groove 4233 to rotatably connect to the connecting member 423 through the first connecting sliding groove 4233. The shaft cover 41 is provided with a first shaft cover sliding groove 411 adapted to the first main swing member 4211. At least a part of the first main swing member 4211 is located in the first shaft cover sliding groove 411 to rotatably connect to the shaft cover 41 through the first shaft cover sliding groove 411, so that when a position of the shaft cover 41 remains unchanged, the connecting member 423 can be rotated relative to the shaft cover 41 to fold or unfold the first body 20 and the second body 30.

It should be noted that the projection on the plane formed by the X-axis and the Z-axis refers to the projection on the plane formed by the X-axis and the Y-axis when the foldable mobile phone 100 is in an unfolded state. Details are the same in the following examples, and will not be repeated again.

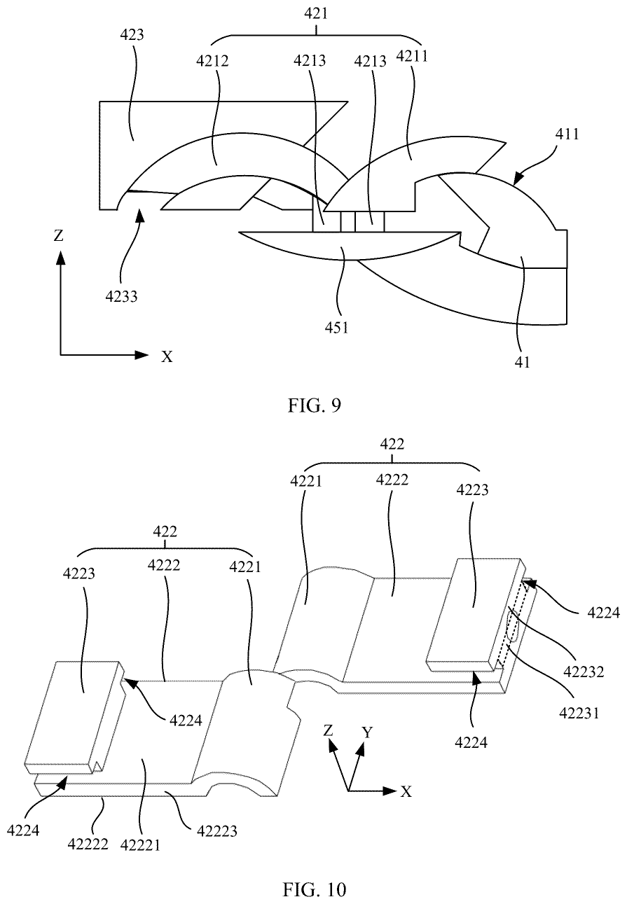

FIG. 10 is a diagram of a structure of a secondary swing arm group according to an embodiment of this application. As shown in FIG. 10, the secondary swing arm 422 includes a swing arm rotating member 4221 and a sliding member 4222 integrally formed with the swing arm rotating member 4221. A cross-sectional shape of the swing arm rotating member 4221 is, for example, arc-shaped or approximately arc-shaped, that is, a projection of the swing arm rotating member 4221 on a plane formed by the X-axis and the Z-axis is arc-shaped or approximately arc-shaped. The sliding member 4222 is, for example, flat plate-shaped. The sliding member 4222 includes a first sliding surface 42221 and a second sliding surface 42222 that are disposed opposite to each other along the Z-axis direction, and further includes a side sliding surface 42223 connecting the first sliding surface 42221 to the second sliding surface 42222. The swing arm rotating member 4221 is fastened to the side sliding surface 42223 to fixedly connect to the sliding member 4222. The first surface 42221 of the sliding member 4222 is provided with a first protrusion 4223. The first protrusion 4223 includes a first protruding portion 42231 and a second protruding portion 42232 that are sequentially disposed along the Z-axis direction. A size of the first protruding portion 42231 in the Y-axis direction is less than a size of the second protruding portion 42232 in the Y-axis direction, so that the second protruding portion 42232 and the first surface 42221 form at least one swing arm sliding groove 4224. FIG. 10 is described by using an example in which the second protruding portion 42232 and the first surface 42221 form two swing arm sliding grooves 4224 and the two swing arm sliding grooves 4224 are opposite to each other along the Y-axis direction.

It should be noted that this embodiment of this application is described by using an example in which the swing arm rotating member 4221 and the sliding member 4222 are integrally formed, but this shall not constitute any limitation to this application. For example, the swing arm rotating member 4221 and the sliding member 4222 may alternatively be separately formed, and fixedly connected together in a manner of welding or bonding.

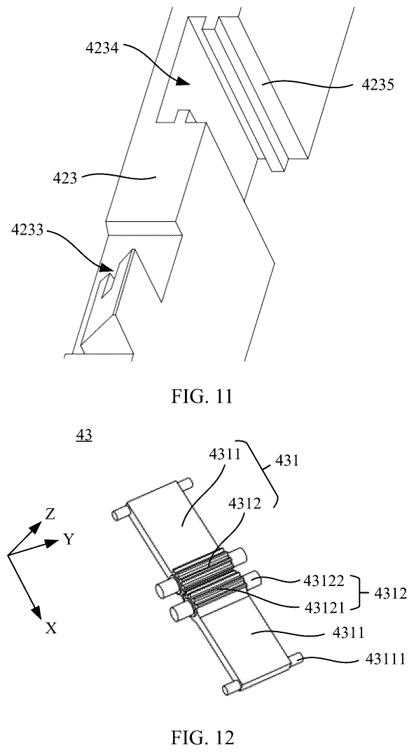

FIG. 11 is a diagram of a partial structure of a connecting member according to an embodiment of this application. As shown in FIG. 11, the connecting member 423 is provided with a second connecting sliding groove 4234 adapted to the sliding member 4222, and a first protruding strip 4235 adapted to the swing arm sliding groove 4224 is formed on a side wall of the second connecting sliding groove 4234. The first protruding strip 4235 is slided in the swing arm sliding groove 4224, so that the secondary swing arm 422 is slidably connected to the connecting member 423.

The shaft cover 41 is provided with a second shaft cover sliding groove (not shown in the figure) adapted to the swing arm rotating member 4221. At least a part of the swing arm rotating member 4221 is located in the second shaft cover sliding groove to rotatably connect to the shaft cover 41 through the second shaft cover sliding groove, so that when the position of the shaft cover 41 remains unchanged, the connecting member 423 can be rotated relative to the shaft cover 41 to fold or unfold the first body 20 and the second body 30.

As can be learned from the foregoing content, the main swing arm 421 is separately rotatably connected to the connecting member 423 and the shaft cover 41; and the secondary swing arm 422 is slidably connected to the connecting member 423, and is rotatably connected to the shaft cover 41. The main swing arm 421, the secondary swing arm 422, the connecting member 423, and the shaft cover 41 form a linkage mechanism to control a movement of the connecting member 423 and implement a rotating movement of the rotating shaft structure 40, so that the first body 20 and the second body 30 can be folded or unfolded, that is, the foldable mobile phone 100 can be folded or unfolded.

It should be noted that a quantity and a disposing position of synchronization mechanisms 43 are not limited in this embodiment of this application. A person skilled in the art may select the quantity and the disposing position of synchronization mechanisms 43 based on an actual situation. This embodiment of this application is described by using an example in which there are two synchronization mechanisms 43 and both are evenly disposed on the shaft cover 41 separately.

FIG. 12 is a diagram of a structure of a synchronization mechanism according to an embodiment of this application. As shown in FIG. 12, the synchronization mechanism 43 includes two synchronization members 431 arranged side by side along an X-axis direction. The synchronization member 431 includes a synchronization swing arm 4311 and a gear 4312. The gears 4312 of the two synchronization members 431 mesh with each other. The synchronization swing arms 4311 of the two synchronization members 431 along the X-axis direction are separately disposed on two sides of the two gears 4312 meshing with each other.

Still refer to FIG. 12. The gear 4312 includes a gear portion 43121 and two gear rotating portions (also referred to as gear shafts) 43122 located on two sides of the gear portion 43121 along a Y-axis direction. The two gears 4312 mesh with each other by using the gear portions 43121. The shaft cover 41 is provided with a rotating hole (not shown in the figure) adapted to the gear rotating portion 43122. The gear rotating portions 43122 of the two gears 4312 are correspondingly inserted into the rotating holes one by one, so that the synchronization mechanism 43 is rotatably connected to the shaft cover 41. Two side walls of an end of the synchronization swing arm 4311 far away from the gear 4312 are provided with two first protruding posts 43111 disposed opposite to each other along the Y-axis direction. Extension directions of the two first protruding posts 43111 are opposite.

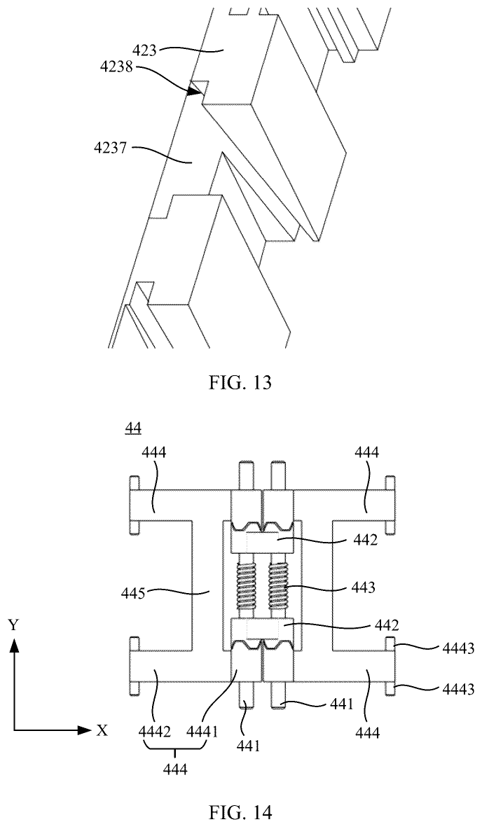

FIG. 13 is a diagram of a partial structure of a connecting member according to an embodiment of this application. As shown in FIG. 13, the connecting member 423 is provided with a third connecting sliding groove 4237 adapted to the synchronization swing arm 4311, a side wall of the third connecting sliding groove 4237 is partially recessed to form a first groove 4238 adapted to the two first protruding posts 43111, and the first protruding posts 43111 are slided and rotated in the first groove 4238, so that the synchronization mechanism 43 is slidably and rotatably connected to the connecting member 423. The groove 4238 has a slope to facilitate sliding of the synchronization member 431.

As can be learned according to the foregoing content, the synchronization mechanism 43 slidably and rotatably cooperates with the connecting member 423 by using the protruding post 43111. The gears 4312 mesh with each other to synchronously rotate the first connecting member 4231 and the second connecting member 4232, ensuring synchronization of the first connecting member 4231 and the second connecting member 4232, and further ensuring synchronization of the first body 20 and the second body 30.

The damping mechanism 44 provides a damping force. In a process of folding or unfolding the foldable mobile phone 100, a folding and unfolding feel can be implemented. A quantity of damping mechanisms 44 is not limited in this embodiment of this application. A person skilled in the art may perform arrangement based on an actual situation. FIG. 1 to FIG. 4 are described by using an example in which there are three damping mechanisms 44 and the three damping mechanisms 44 are evenly disposed on the shaft cover 41 separately. When there are three damping mechanisms 44, the costs do not increase due to an increase in the quantity of damping mechanisms 44, and the folding and unfolding feel is not affected due to a reduced damping force caused by an extremely small quantity of damping mechanisms 44.

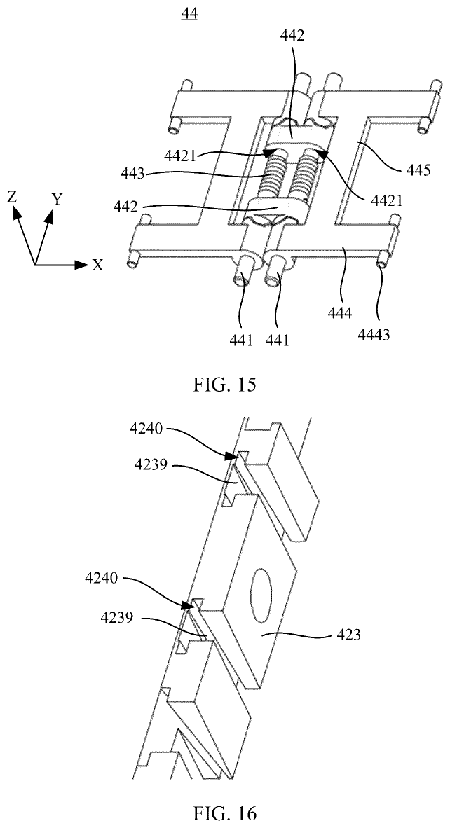

FIG. 14 is a top view of a damping mechanism according to an embodiment of this application. FIG. 15 is a three-dimensional view of a damping mechanism according to an embodiment of this application. As shown in FIG. 14 and FIG. 15, the damping mechanism 44 includes two pin shafts 441, two concave gears 442, two first springs 443, and four damping swing arms 444. To be distinguished from a damping mechanism in the following example, the damping mechanism 44 in this example may also be referred to as a concave-convex gear damping mechanism. The two pin shafts 441 are arranged side by side along an X-axis direction, and each pin shaft 441 extends along a Y-axis direction. Each concave gear 442 has two concave gear holes 4421 arranged side by side along the X-axis direction. The concave gear 442 is sleeved on the pin shafts 441 through the two concave gear holes 4421, and there is a gap between the two concave gears 442. The two first springs 443 are respectively sleeved on the two pin shafts 441, and are separately located at the gap between the two concave gears 442.

The damping swing arm 444 includes a rotary annular cam 4441 and a swinging member 4442 that is located on a side of the rotary annular cam 4441 and that is fixedly connected to the rotating cam 4441. Two side walls of an end of the swinging member 4442 far away from the rotating cam 4441 are provided with two second protruding posts 4443 extending along the Y-axis direction. Extension directions of the two second protruding posts 4443 are opposite. Along the Y-axis direction, two damping swing arms 444 are separately sleeved on one of the pin shafts 441 by using respective rotary annular cams 4441, and the two rotary annular cams 4441 each are disposed neighboring to one concave gear 442 and are both located on a side of the concave gear 442 facing away from the first spring 443; and the other two damping swing arms 444 are separately sleeved on the other pin shaft 441 by using respective rotary annular cams 4441, and the two rotary annular cams 4441 each are disposed neighboring to one concave gear 442 and are both located on a side of the concave gear 442 facing away from the first spring 443.

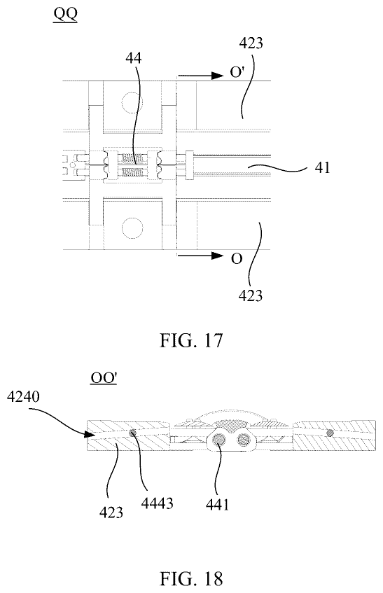

FIG. 16 is a diagram of a partial structure of a connecting member according to an embodiment of this application. As shown in FIG. 16, the connecting member 423 is provided with a fifth connecting sliding groove 4239 adapted to the damping swing arm 444, and a side wall of the fifth connecting sliding groove 4239 is partially recessed to form a second groove 4240 adapted to the two second protruding posts 4443. With reference to FIG. 17 and FIG. 18.

FIG. 17 is an enlarged view of a region QQ in FIG. 3. FIG. 18 is a cross-sectional view of FIG. 17 along a direction OO′. As shown in FIG. 15 to FIG. 18, when the concave gear 442, the first spring 443, and the damping swing arm 444 are sleeved on the pin shaft 441, two ends of the pin shaft 441 are exposed. The exposed portions of the pin shaft 441 are fixedly connected to the shaft cover 41, in other words, the damping mechanism 44 is fixedly connected to the shaft cover 41 through the pin shaft 441. The second protruding post 4443 is slided and rotated in the second groove 4240, so that the damping mechanism 44 is slidably and rotatably connected to the connecting member 423.

To ensure synchronization of two damping swing arms 444 located on a same pin shaft 441, a connection portion 445 is disposed between the two damping swing arms 444, and is configured to connect to the two damping swing arms 444.

Specifically, when the damping swing arm 444 is slidably and rotatably connected to the connecting member 423, a movement of the connecting member 423 is converted into a linear movement (a movement on the pin shaft 441 along the Y-axis direction) of the first spring 443 by using a cam surface (a contact surface between the concave gear 442 and the rotary annular cam 4441), to compress the first spring 443 and generate a damping force.

As can be learned from the foregoing content, the rotating shaft structure 40 uses three damping mechanisms 44, and the three damping mechanisms 44 are evenly distributed on the shaft cover 41. By using the damping mechanism 44 formed by three groups of concave-convex gears, the damping force of the rotating shaft structure 40 is increased to implement the folding and unfolding feel in a folding and unfolding process. In addition, a pressure on the cam surface of each damping mechanism 44 is evenly distributed, avoiding problems such as a relatively large pressure on the cam surface, easy abrasion of the cam surface, and a short service life. Besides, in this example, the damping mechanism 44 has a simple structure and low costs, and is easy to machine.

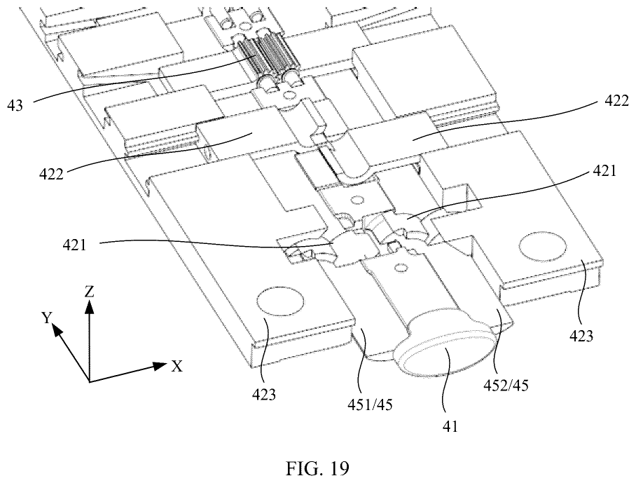

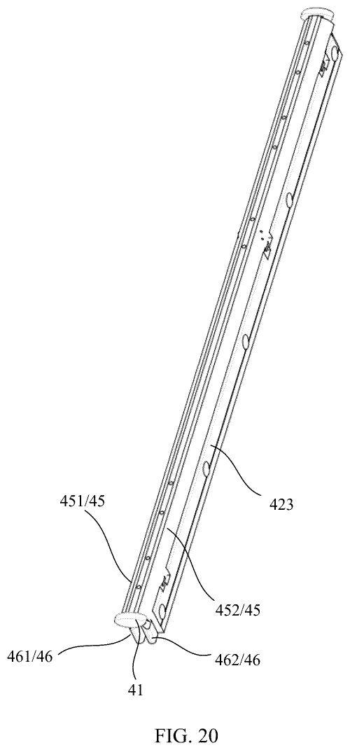

FIG. 19 is a diagram of a partial structure of a rotating shaft structure according to an embodiment of this application. To clearly show a position of the support door panel 45, the decorating door panel is not shown in FIG. 19. As shown in FIG. 7, FIG. 9, and FIG. 19, the first main swing member 4211 and the second main swing member 4212 of the main swing arm 421 each are provided with a fastening post 4213. An extension direction of the fastening post 4213 is opposite to a bending direction of the first main swing member 4211 and the second main swing member 4212. A first main swing member 4211 and a second main swing member 4212 of one main swing arm 421 in the main swing arm group are fixedly connected to one support door panel 45 by using fastening posts 4213, for example, are fixedly connected to the first support door panel 451. A first main swing member 4211 and a second main swing member 4212 of another main swing arm 421 in the main swing arm group are fixedly connected to another support door panel 45 by using fastening posts 4213, for example, are fixedly connected to the second support door panel 452. In this way, the two support door panels 45 are separately disposed on two sides of the shaft cover 41 along the X-axis direction. In other words, the support door panel 45 is fixedly connected to the main swing arm 421, and a movement of the main swing arm 421 controls a movement of the support door panel 45. The first display unit 10 is supported by the first support door panel 451 and the second support door panel 452. When the terminal is in the unfolded state, the first display unit 10 is supported to prevent the first display unit 10 from collapsing due to pressing. When the terminal is in the folded state (as shown in FIG. 20), the bending region of the first display unit 10 is supported to prevent the first display unit 10 from collapsing.

A material of the support door panel 45 is not limited in this embodiment of this application, and a person skilled in the art may select the material based on an actual situation. For example, the material of the support door panel 45 includes an ultra-high polymer material. When the material of the support door panel 45 is an ultra-high polymer material, the support door panel 45 may be integrally formed. In this way, a carrying capability of the support door panel 45 for the first display unit 10 can be improved, reliability of supporting the first display unit 10 can be improved, machining reliability of the support door panel 45 can be improved, and machining costs can be reduced.

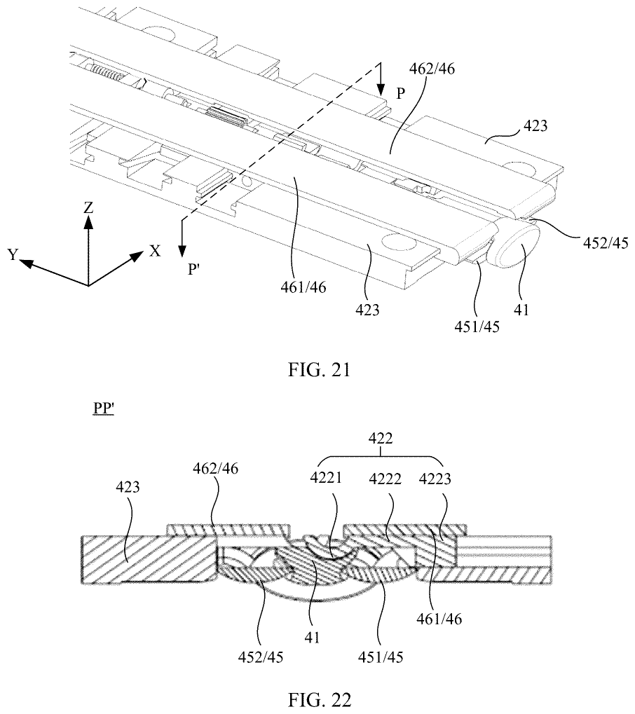

FIG. 21 is a diagram of a partial structure of a rotating shaft structure according to an embodiment of this application. FIG. 22 is a section view of FIG. 21 along a direction PP'. As shown in FIG. 21 and FIG. 22, the first decorating door panel 461 is fixedly connected to a sliding member 4222 of one secondary swing arm 422 in the secondary swing arm group, the second decorating door panel 462 is fixedly connected to a sliding member 4222 of another secondary swing arm 422 in the secondary swing arm group, and a movement of the secondary swing arm 422 controls a movement of the decorating door panel 46.

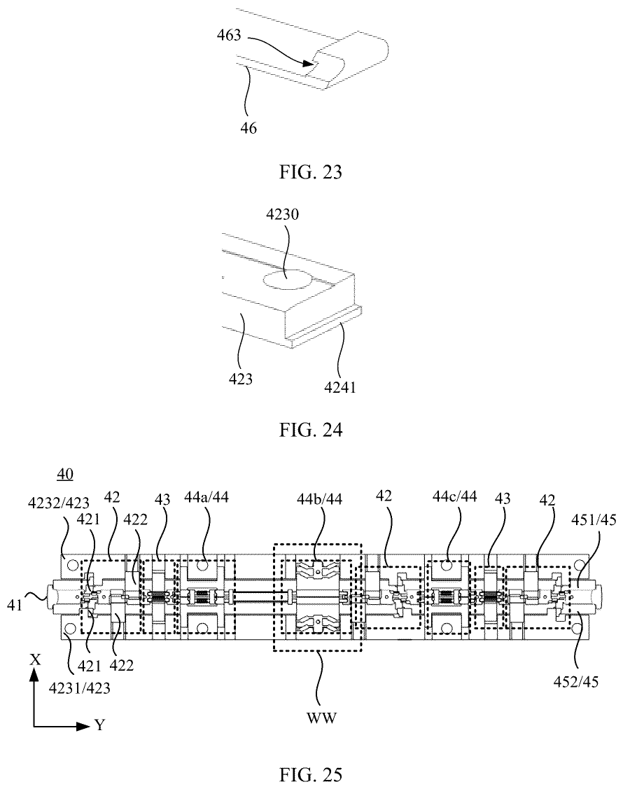

FIG. 23 is a diagram of a partial structure of a connecting member according to an embodiment of this application. FIG. 24 is a diagram of a partial structure of a decorating door panel according to an embodiment of this application. With reference to FIG. 23 and FIG. 24, along the Y-axis direction, two opposite ends of the decorating door panel 46 are partially bent, and a decorating sliding groove 463 is formed between a bent portion and an unbent portion; and correspondingly, along the Y-axis direction, two opposite ends of the connecting member 423 each are provided with a second protrusion 4241, and the second protrusion 4241 is located in the decorating sliding groove 463. When the movement of the secondary swing arm 422 controls the decorating door panel 46 to move, the second protrusion 4241 is slided in the decorating sliding groove 463. The first decorating door panel 461 and the second decorating door panel 462 can cover at least a part of the rotating mechanism 42, the synchronization mechanism 43, and the damping mechanism 44 to protect these structures.

As can be learned from the specific descriptions of these structures, the rotating shaft structure 40 provided in the embodiments of this application can increase the damping force of the damping mechanism. In addition, the damping mechanism not only can provide a flattening force, but also can provide a closing force, adjusting the folding and unfolding feel of the rotating shaft structure 40, helping improve user experience, and increasing a service life of the rotating shaft structure 40 when applied to an outward foldable terminal. In this way, a problem of severer abrasion caused by a relatively large pressure on the cam surface when a single damping mechanism 44 is used is avoided. Furthermore, the damping mechanism 44 has a simple structure and low costs. In addition, because the support door panel 45 is relatively flat and is integrally formed, machining reliability is improved, machining costs are reduced, the carrying capability of the support door panel 45 for the first display unit 10 is improved, and a problem such as a screen crease is ameliorated. In addition, the main swing arm 421, the secondary swing arm 422, and the synchronization mechanism 43 have simple structures and cooperate with each other to ensure bending reliability of the entire terminal, reduce a weight of the entire terminal, and reduce costs.

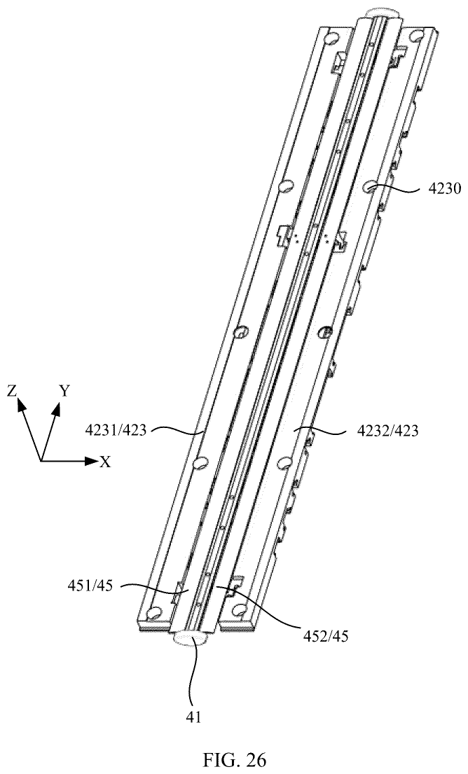

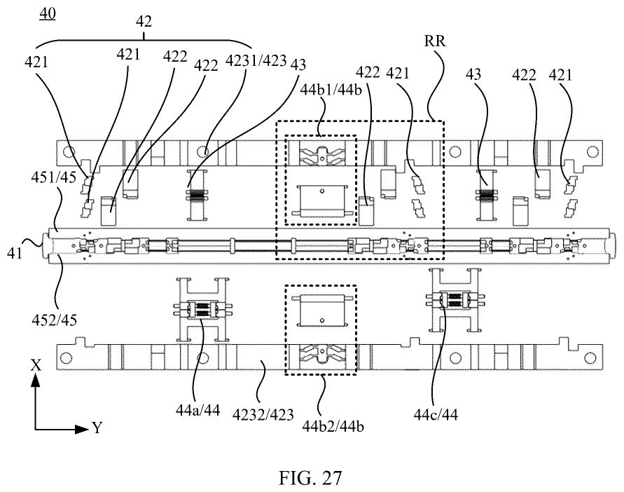

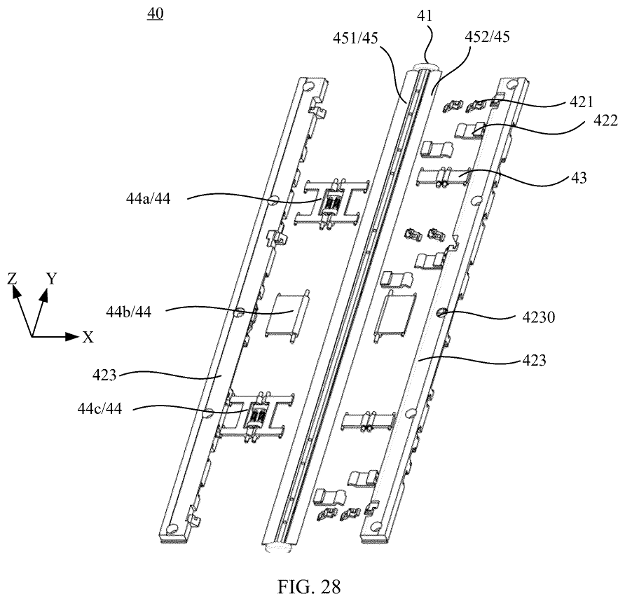

In another example, FIG. 25 is a diagram of a front surface structure of another rotating shaft structure according to an embodiment of this application; FIG. 26 is a diagram of a back surface structure of another rotating shaft structure according to an embodiment of this application; FIG. 27 is an exploded view of the rotating shaft structure shown in FIG. 25; and FIG. 28 is an exploded view of the rotating shaft structure shown in FIG. 26. It should be noted that none of FIG. 25, FIG. 26, FIG. 27, and FIG. 28 has shown the decorating door panel 46. It can be understood that during actual disposing, the rotating shaft structure in the embodiments of this application may include the decorating door panel 46. As shown in FIG. 25, FIG. 26, FIG. 27, and FIG. 28, a difference between this example and the foregoing example is that among three damping mechanisms 44, one damping mechanism 44 is different from the other two damping mechanisms 44. Specifically, the three damping mechanisms 44 include a first damping mechanism 44a, a second damping mechanism 44b, and a third damping mechanism 44c. Along a Y-axis direction, the first damping mechanism 44a, the second damping mechanism 44b, and the third damping mechanism 44c are sequentially disposed. The second damping mechanism 44b is located between the first damping mechanism 44a and the third damping mechanism 44c. The first damping mechanism 44a and the third damping mechanism 44c are, for example, the concave-convex gear damping mechanism in the foregoing example.

For a specific structure of the damping mechanism, refer to the content in the foregoing example. Details are not described herein again. The following describes a specific structure of the second damping mechanism 44b.

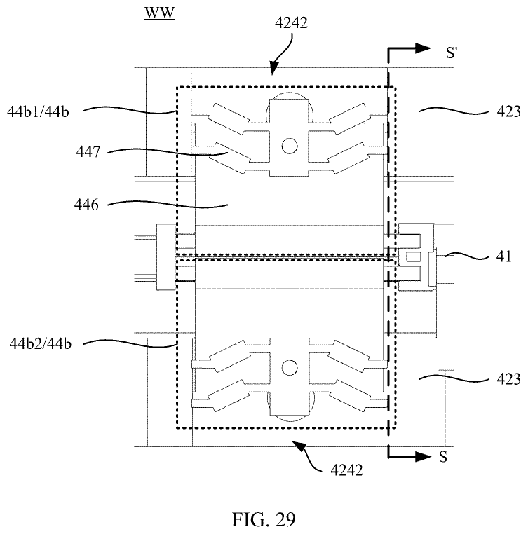

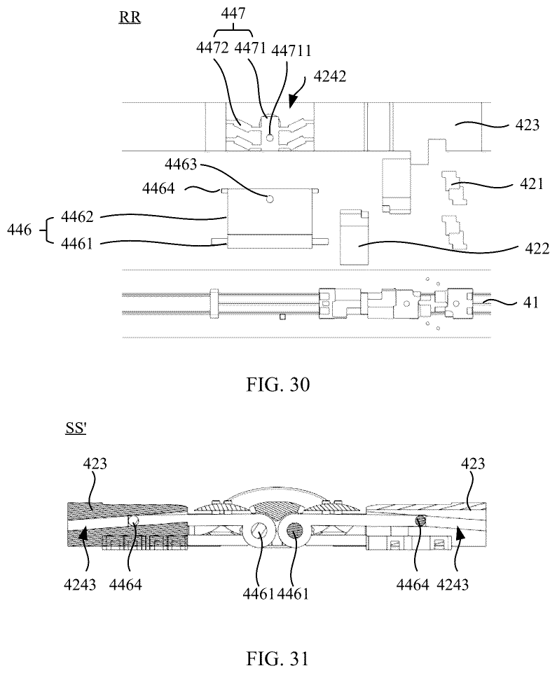

FIG. 29 is an enlarged view of a region WW in FIG. 25. FIG. 30 is an enlarged view of a region RR in FIG. 27. As shown in FIG. 29 and FIG. 30, the second damping mechanism 44b includes two smoothing members of a same structure. The two smoothing members are a first smoothing member 44b1 and a second smoothing member 44b2. For a purpose of distinction, the second damping mechanism 44b in this example is also referred to as a smoothing damping mechanism.

The smoothing member includes a smoothing swing arm 446 and a flexible unit 447. The smoothing swing arm 446 includes a rotating shaft 4461 and a sliding portion 4462 located on a side of the rotating shaft 4461. An upper surface of the sliding portion 4462 is provided with a limiting block 4463, and two side walls of an end of the sliding portion 4462 far away from the rotating shaft 4461 are provided with two third protruding posts 4464 extending along the Y-axis direction. Extension directions of two third protruding posts 4464 are opposite (to be specific, one extends along a +Y direction, and the other extends along a −Y direction). The flexible unit 447 includes a connecting rod 4471 and flexible beams 4472 located on two sides of the connecting rod 4471. The connecting rod 4471 is provided with a limiting hole 44711.

The shaft cover 41 is provided with rotating holes (not shown in the figure) adapted to the rotating shafts 4461. The rotating shafts 4461 of the smoothing swing arm 446 are inserted into the rotating holes of the shaft cover 41 to rotatably connect the second damping mechanism 44b to the shaft cover 41.

FIG. 31 is a cross-sectional view of FIG. 29 along a direction SS′. The connecting member 423 is provided with a fourth connecting sliding groove 4242, and a side wall of the fourth connecting sliding groove 4242 is partially recessed to form third grooves 4243 adapted to two third protruding posts 4464. The third protruding posts 4464 are located in the third grooves 4243. The flexible beams 4472 located on two sides of the connecting rod 4471 are separately fastened to a side wall of the fourth connecting sliding groove 4242, that is, an unrecessed region of the side wall, to fasten the flexible unit 447 to the connecting member 423. In addition, the limiting block 4463 of the smoothing swing arm 446 is clamped in the limiting hole 44711 of the flexible unit 447, so that the smoothing swing arm 446 is fixedly connected to the flexible unit 447. When the connecting member 423 is folded or unfolded with the first body 20 and the second body 30, the third protruding post 4464 is slided and rotated in the third groove 4243, so that the damping mechanism 44 is slidably and rotatably connected to the connecting member 423.

Specifically, in a folding or unfolding process of the rotating shaft structure 40, the connecting member 423 drives the sliding portion 4462 of the smoothing swing arm 446 to slide, so that the sliding portion 4462 drives the connecting rod 4471 to move up and down (vertical to the Y-axis direction) to compress the flexible beam 4472 to generate a damping force. At different folding or unfolding angles, the second damping mechanism 44b reaches a stable state, helping maintain a hovering, unfolded, or folded state of the rotating shaft structure 40.

For example, when the first body 20 and the second body 30 change from the folded state to the unfolded state, before an angle between a plane on which the first body 20 is located and a plane on which the second body 30 is located is less than a preset angle, the flexible beam 4472 buckles, enters a closing force interval, and generates a closing force, and the second damping mechanism 44b reaches a first stable state. In this case, if a user lets go, the first body 20 and the second body 30 return to initial positions, that is, return to the folded state. However, when the angle between the plane on which the first body 20 is located and the plane on which the second body 30 is located is the preset angle, the flexible beam 4472 is between the closing force interval and an unfolding force interval, and the second damping mechanism 44b reaches a balanced stable state. In this case, if the user lets go, the first body 20 and the second body 30 remain in the current positions, that is, the angle between the plane on which the first body 20 is located and the plane on which the second body 30 is located is still the preset angle. When the angle between the plane on which the first body 20 is located and the plane on which the second body 30 is greater than the preset angle, the flexible beam 4472 still buckles, enters the unfolding force interval, and generates an unfolding force, and the second damping mechanism 44b reaches a second stable state, so that the connecting member 423 is slided relative to the second damping mechanism 44b, helping unfold the first body 20 and the second body 30.

It should be noted that this example is described by using an example in which the rotating shaft structure 40 includes three damping mechanisms 44, the three damping mechanisms 44 includes two concave-convex gear damping mechanisms and one smoothing damping mechanism, and the smoothing damping mechanism is located between the two concave-convex gear damping mechanisms, but this shall not constitute any limitation to this application. A person skilled in the art may perform arrangement based on an actual situation. In another optional embodiment of this application, the rotating shaft structure 40 may further include three smoothing damping mechanisms, or include two smoothing damping mechanisms and one concave-convex gear damping mechanism, or so on. A specific disposing position and a specific connection relationship are the same as those in the foregoing examples. Details are not described herein again. For details, refer to the corresponding content in the foregoing two examples.

As can be learned from the specific descriptions of the foregoing structures, the rotating shaft structure 40 provided in the embodiments of this application can increase the damping force of the damping mechanism, and disposing of the second damping mechanism helps maintain the hovering, folded, and unfolded state of the rotating shaft structure 40, adjusting the folding and unfolding feel of the rotating shaft structure 40, and helping improve user experience. In addition, when the rotating shaft structure 40 is applied to an outward foldable terminal, the service life of the rotating shaft structure 40 can be increased. In this way, a problem of severer abrasion caused by a relatively large pressure on the cam surface when a single damping mechanism 44 is used is avoided. Furthermore, the damping mechanism 44 has a simple structure and low costs. In addition, because the support door panel 45 is relatively flat and is integrally formed, machining reliability is improved, machining costs are reduced, the carrying capability of the support door panel 45 for the first display unit 10 is improved, and a problem such as a screen crease is ameliorated. In addition, the main swing arm 421, the secondary swing arm 422, and the synchronization mechanism 43 have simple structures and cooperate with each other to ensure bending reliability of the entire terminal, reduce a weight of the entire terminal, and reduce costs.

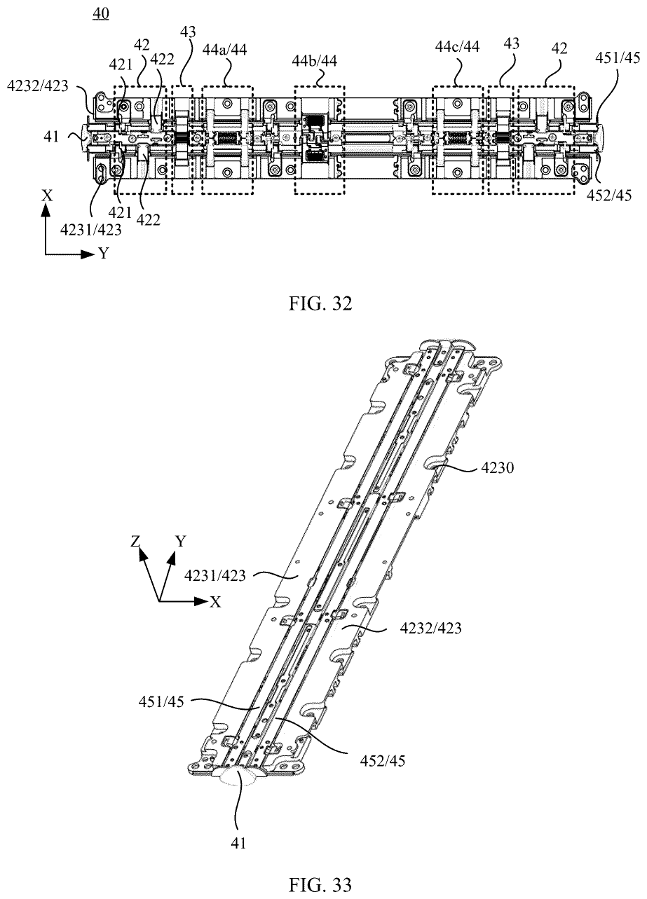

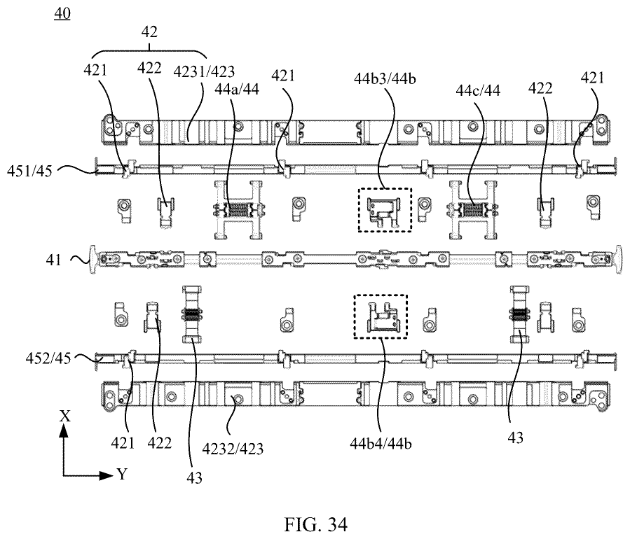

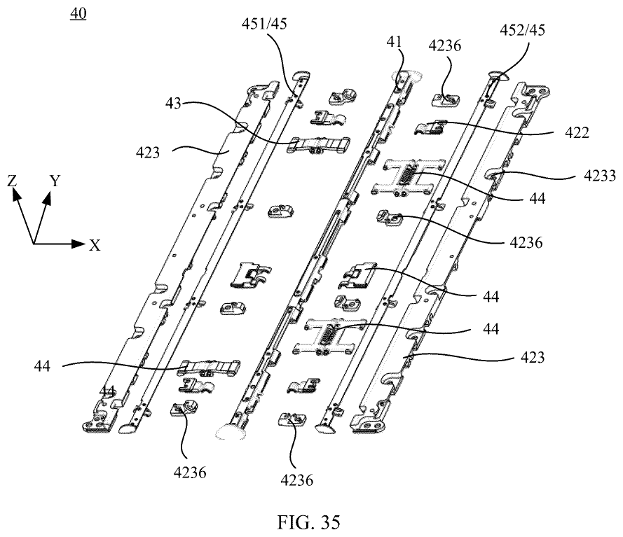

In still another example, FIG. 32 is a diagram of a front surface structure of another rotating shaft structure according to an embodiment of this application; FIG. 33 is a diagram of a back surface structure of another rotating shaft structure according to an embodiment of this application; FIG. 34 is an exploded view of the rotating shaft structure shown in FIG. 32; and FIG. 35 is an exploded view of the rotating shaft structure shown in FIG. 33. It should be noted that none of FIG. 32, FIG. 33, FIG. 34, and FIG. 35 has shown the decorating door panel 46. It can be understood that during actual disposing, the rotating shaft structure 40 in the embodiments of this application may include the decorating door panel 46. As shown in FIG. 32, FIG. 33, FIG. 34, and FIG. 35, a difference between this example and the first example is that among three damping mechanisms 44, one damping mechanism 44 is different from the other two damping mechanisms 44. Specifically, the three damping mechanisms 44 include a first damping mechanism 44a, a second damping mechanism 44b, and a third damping mechanism 44c. Along a Y-axis direction, the first damping mechanism 44a, the second damping mechanism 44b, and the third damping mechanism 44c are sequentially disposed. The second damping mechanism 44b is located between the first damping mechanism 44a and the third damping mechanism 44c. The first damping mechanism 44a and the third damping mechanism 44c are, for example, the concave-convex gear damping mechanism in the foregoing example. For a specific structure of the damping mechanism, refer to the content in the foregoing example. Details are not described herein again. The following describes a specific structure of the second damping mechanism 44b.

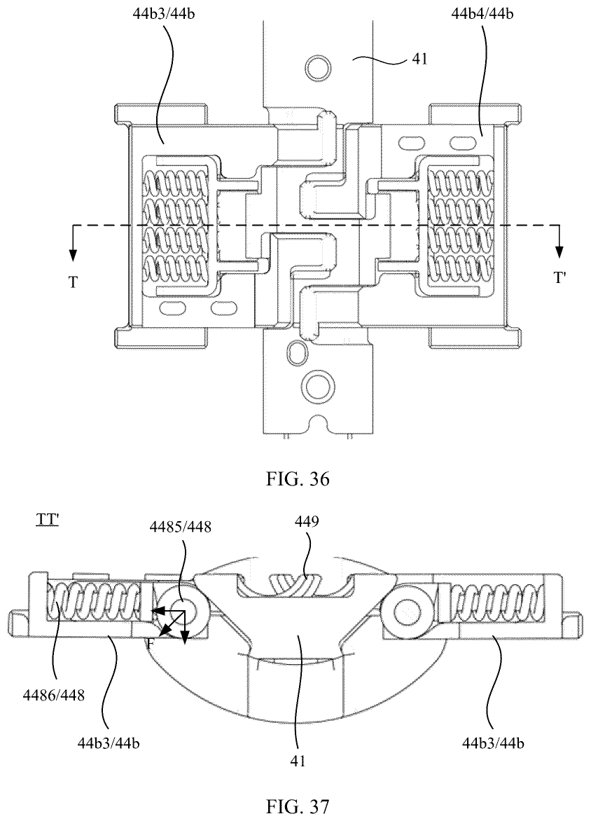

FIG. 36 is a partial diagram of a position relationship of a second damping mechanism and a shaft cover according to an embodiment of this application. FIG. 37 is a cross-sectional view of FIG. 36 along a direction TT′. As shown in FIG. 36 and FIG. 37, the second damping mechanism 44b includes two lateral members of a same structure. The two lateral members are a first lateral member 44b3 and a second lateral member 44b3. For a purpose of distinction, the second damping mechanism 44b in this example is also referred to as a lateral damping mechanism.

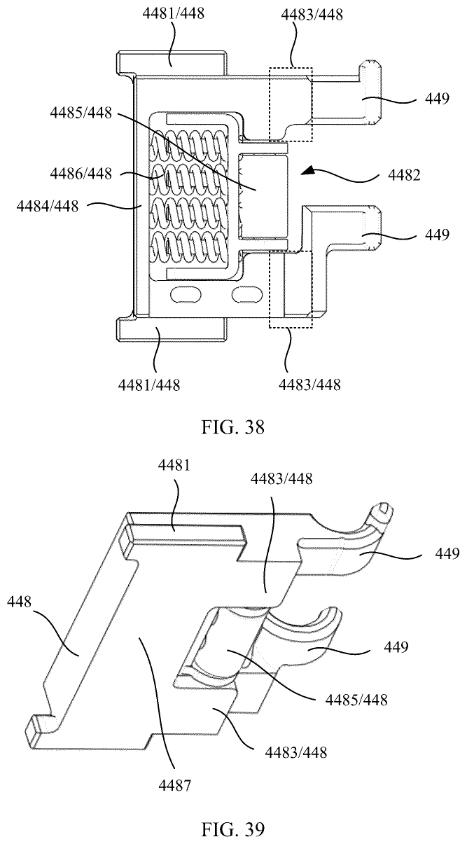

FIG. 38 is a top view of a second damping mechanism according to an embodiment of this application. FIG. 39 is a three-dimensional view of a second damping mechanism according to an embodiment of this application. As shown in FIG. 38 and FIG. 39, the lateral member includes a lateral swing arm 448 and a lateral rotating portion 449. A cross-sectional shape of the lateral rotating portion 449 is, for example, arc-shaped or approximately arc-shaped, that is, a projection of the lateral rotating portion 449 on a plane formed by the X-axis and the Y-axis is arc-shaped or approximately arc-shaped.

Along the Y-axis direction, two side walls of the lateral swing arm 448 each are provided with a second protruding strip 4481, the connecting member 423 is provided with a fifth connecting sliding groove (not shown in the figure), a side wall of the fifth connecting sliding groove is partially recessed to form a fourth groove (not shown in the figure) adapted to the two second protruding strips 4481, and the second protruding strips 4481 are located in the fourth groove. When the connecting member 423 is folded or unfolded with the first body 20 and the second body 30, the second protruding strips 4481 are slided in the fourth groove, so that the second damping mechanism 44 is slidably connected to the connecting member 423.

The shaft cover 41 is provided with a third shaft cover sliding groove (not shown in the figure) adapted to the lateral rotating portion 449. The lateral rotating portion 449 is located in the third shaft cover sliding groove, so that the second damping mechanism 44b is rotatably connected to the shaft cover 41. In this way, when the position of the shaft cover 41 remains unchanged, the lateral swing arm 448 can be rotated relative to the shaft cover 41.

For example, the lateral member includes two lateral rotating portions 449 that are spaced away from each other. The lateral swing arm 448 is of an unclosed annular structure, to be specific, the lateral swing arm 448 has an opening 4482. The opening 4482 is provided, so that the lateral swing arm 448 has two end portions 4483 that are spaced away from each other. The two lateral rotating portions 449 are respectively connected to the two end portions 4483 of the lateral swing arm 448. A part of the shaft cover 41 is located in a gap between the two lateral rotating portions 449.

The annular lateral swing arm 448 is provided with a support member 4484 and a roller 4485 rotatably connected to the support member 4484. At least one second spring 4486 is sleeved on the support member 4484. Two opposite ends of the second spring 4486 are respectively fixedly connected to the support member 4484 and the roller 4485. A side wall of the shaft cover 41 located in the gap between the two lateral rotating portions 449 is in contact with the roller 4485.

Optionally, to better support and protect the second spring 4486, a portion of the lateral swing arm 448 opposite to the second spring 4486 is provided with a bottom surface 4487. That is, in an unfolded state, a projection of the second spring 4486 on a plane formed by the X-axis and the Y-axis is located on a projection of the bottom surface 4487 on the plane formed by the X-axis and the Y-axis.

Specifically, when the connecting member 423 is folded or unfolded with the first body 20 and the second body 30, the connecting member 423 drives the lateral swing arm 448 to rotate relative to the shaft cover 41. The roller 4485 is moved around a side wall of the shaft cover 41. The shaft cover 41 squeezes the roller 4485, and the roller 4485 further compresses the second spring 4486. Correspondingly, a load F is applied to the roller 4485 to generate a damping force.

That is, in the three damping mechanisms provided in this embodiment of this application, the concave-convex gear damping mechanism provides a folding and unfolding feel force. A force between the roller and the shaft cover in the lateral damping mechanism avoids a problem that a closing force cannot be generated because the lateral damping mechanism has only a flattening force, improving an unfolding retention force of the rotating shaft structure. In this way, the foldable terminal has a better feel in a folding or unfolding process, helping improve user experience.

It should be noted that this example is described by using an example in which the rotating shaft structure 40 includes three damping mechanisms 44, the three damping mechanisms 44 includes two concave-convex gear damping mechanisms and one lateral damping mechanism, and the lateral damping mechanism is located between the two concave-convex gear damping mechanisms, but this shall not constitute any limitation to this application. A person skilled in the art may perform arrangement based on an actual situation. In another optional embodiment of this application, the rotating shaft structure 40 may further include two lateral damping mechanisms and one concave-convex gear damping mechanism, one smoothing damping mechanism and two lateral damping mechanisms, two smoothing damping mechanisms and one lateral damping mechanism, or one smoothing damping mechanism, one concave-convex gear damping mechanism, and one lateral damping mechanism. A specific disposing position and a specific connection relationship are the same as those in the foregoing examples. Details are not described herein again. For details, refer to the corresponding content in the foregoing two examples.

It should be noted that in the foregoing examples, for ease of preparing the connecting member 423, the connecting member 423 may be integrally formed (for example, the connecting member 423 in the first example and the second example), or the connecting member 423 may be formed by combining a plurality of structural members (for example, the plurality of structural members 4236 in the third example).

As can be learned from the specific descriptions of the foregoing structures, the rotating shaft structure 40 provided in the embodiments of this application can increase the damping force of the damping mechanism. The damping mechanism not only can generate a flattening force, but also can generate a closing force. The concave-convex gear damping mechanism provides a folding and unfolding feel of the rotating shaft structure 40. When the rotating shaft structure 40 is in the unfolded state, the lateral damping mechanism increases an unfolding retention force of the rotating shaft structure 40 by using an acting force between the roller 4485 and the shaft cover 41, helping improve user experience. When the rotating shaft structure 40 is applied to an outward foldable terminal, the service life of the rotating shaft structure 40 can be increased. In this way, a problem of severer abrasion caused by a relatively large pressure on the cam surface when a single damping mechanism 44 is used is avoided.

Besides, a problem that the closing force cannot be generated when there is only a lateral damping mechanism can also be avoided. In addition, because the support door panel 45 is relatively flat and is integrally formed, machining reliability is improved, machining costs are reduced, the carrying capability of the support door panel 45 for the first display unit 10 is improved, and a problem such as a screen crease is ameliorated. In addition, the main swing arm 421, the secondary swing arm 422, and the synchronization mechanism 43 have simple structures and cooperate with each other to ensure bending reliability of the entire terminal, reduce a weight of the entire terminal, and reduce costs.

In conclusion, the rotating shaft structure 40 provided in the embodiments of this application increases the damping force of the damping mechanism by using three concave-convex gear damping mechanisms 44, three smoothing damping mechanisms 44, a combination of a concave-convex gear damping mechanism 44 and a smoothing damping mechanism 44, a combination of a lateral damping mechanism 44 and a concave-convex gear damping mechanism 44, or a combination of a lateral damping mechanism 44 and a smoothing damping mechanism 44, and adjusts the folding and unfolding feel of the rotating shaft structure 40, helping improve the user experience. In addition, because the support door panel 45 is relatively flat and is integrally formed, machining reliability is improved, machining costs are reduced, the carrying capability of the support door panel 45 for the first display unit 10 is improved, and a problem such as a screen crease is ameliorated. In addition, the main swing arm 421, the secondary swing arm 422, and the synchronization mechanism 43 have simple structures and cooperate with each other to ensure bending reliability of the entire terminal, reduce a weight of the entire terminal, and reduce costs.

The foregoing descriptions and embodiments are merely intended to describe the technical solutions of this application, rather than limit this application. Although this application is described in detail with reference to the foregoing embodiments, a person of ordinary skill in the art should understand that modifications can still be made to the technical solutions described in the foregoing embodiments or equivalent replacements can be made to some technical features thereof, without departing from the scope of the technical solutions of the embodiments of this application.

1. A rotating shaft structure, applied to an outward foldable terminal, wherein the outward foldable terminal comprises a first body, a second body, and the rotating shaft structure connecting the first body to the second body, and the rotating shaft structure comprises:
a shaft cover;
two connecting members, located on two sides of the shaft cover, and configured to respectively connect to the first body and the second body;
a rotating mechanism, rotatably connected to the shaft cover and slidably and rotatably connected to the connecting members, and configured to control movements of the connecting members;
a synchronization mechanism, rotatably connected to the shaft cover and slidably and rotatably connected to the connecting members, and configured to synchronize rotation of the two connecting members; and
a plurality of damping mechanisms, wherein the plurality of damping mechanisms comprise a concave-convex gear damping mechanism and/or a smoothing damping mechanism, wherein
the concave-convex gear damping mechanism comprises a pin shaft, a concave gear, a first spring, and at least two damping swing arms, the pin shaft is fixedly connected to the shaft cover, and the concave gear and the first spring are both sleeved on the pin shaft; the damping swing arm comprises a rotating cam sleeved on the pin shaft and neighboring to and in contact with the concave gear and a swinging member located on a side of the rotating cam, and the swinging members of the two damping swing arms are slidably and rotatably connected to the two connecting members; and when the swinging members and the connecting members are slided and rotated, the first spring is compressed and generates an axial squeezing force, applied between the concave gear and the rotating cam to generate a damping force; and
the smoothing damping mechanism comprises two smoothing members, the smoothing member comprises a smoothing swing arm and a flexible unit, the flexible units of the two smoothing members are respectively fastened to the two connecting members, ends of the smoothing swing arms are rotatably connected to the shaft cover, and other ends of the smoothing swing arms of the two smoothing members are respectively slidably and rotatably connected to the connecting members; the flexible unit comprises a connecting rod and a flexible beam, and the smoothing swing arm is fixedly connected to the connecting rod; and when the other end of the smoothing swing arm and the connecting member are slided and rotated, the connecting rod is driven to move, and the flexible beam is compressed to generate a damping force.

2. The rotating shaft structure according to claim 1, wherein the plurality of damping mechanisms further comprise a lateral damping mechanism; and the lateral damping mechanism comprises two lateral members, the lateral member comprises a lateral swing arm and a lateral rotating portion, the lateral rotating portion is rotatably connected to the shaft cover, and the lateral swing arms of the two lateral members are respectively slidably connected to the two connecting members; and
the lateral swing arm is provided with a support member and a roller rotatably connected to the support member, at least one second spring is sleeved on the support member, two opposite ends of the second spring are respectively fixedly connected to the support member and the roller; and when an angle of a plane on which the two connecting members are located is within a preset angle range, the roller is in contact with a side wall of the shaft cover, the shaft cover squeezes the roller, and the second spring is compressed to generate a damping force.

3. The rotating shaft structure according to claim 1, wherein the rotating mechanism comprises a main swing arm group, and the main swing arm group comprises two main swing arms separately disposed on two sides of the shaft cover; and
the main swing arm comprises a first main swing member and a second main swing member that are fixedly connected, the connecting member is provided with a first connecting sliding groove adapted to the second main swing member, the main swing arm is rotatably connected to the connecting member by using the second main swing member, the shaft cover is provided with a first shaft cover sliding groove adapted to the first main swing member, the main swing arm is rotatably connected to the shaft cover by using the first main swing member, a position of the shaft cover remains unchanged, the first main swing members of the two main swing arms in the main swing arm group are rotated relative to the shaft cover to drive, by using the second main swing members of the two main swing arms in the main swing arm group, the two connecting members to rotate.

4. The rotating shaft structure according to claim 3, wherein cross-sectional shapes of the first main swing member and the second main swing member are both arc-shaped.

5. The rotating shaft structure according to claim 3, wherein the rotating mechanism further comprises a secondary swing arm group, the secondary swing arm group comprises two secondary swing arms separately disposed on two sides of the shaft cover, the secondary swing arm comprises a swing arm rotating member and a sliding member, the swing arm rotating member is fastened to a side wall of the sliding member, the sliding member is provided with a first protrusion, and at least one swing arm sliding groove is formed between the first protrusion and the sliding member; and
the connecting member is provided with a second connecting sliding groove adapted to the sliding member, a first protruding strip adapted to the swing arm sliding groove is formed on a side wall of the second connecting sliding groove, the secondary swing arm is slidably connected to the connecting member by using the swing arm sliding groove, the shaft cover is provided with a second shaft cover sliding groove adapted to the swing arm rotating member, the secondary swing arm is rotatably connected to the shaft cover by using the swing arm rotating member, a position of the shaft cover remains unchanged, the swing arm rotating members of the two secondary swing arms in the secondary swing arm group are rotated relative to the shaft cover to drive, by using the sliding members of the two secondary swing arms in the secondary swing arm group, the two connecting members to rotate.

6. The rotating shaft structure according to claim 1, wherein the synchronization mechanism comprises two synchronization members, the synchronization member comprises a synchronization swing arm and a gear, the gears of the two synchronization members mesh with each other, and the synchronization swing arms of the two synchronization members are separately disposed on two sides of the two gears meshing with each other;
the gear is rotatably connected to the shaft cover by using a gear shaft, two side walls of an end of the synchronization swing arm far away from the gear is provided with a first protruding post; and
the connecting member is provided with a third connecting sliding groove adapted to the synchronization swing arm, a side wall of the third connecting sliding groove is partially recessed to form a first groove adapted to the first protruding post, and the first protruding post is slided and rotated in the first groove, so that the synchronization mechanism is slidably and rotatably connected to the connecting member.

7. The rotating shaft structure according to claim 1, wherein the foldable terminal further comprises a flexible screen, located on a side of the first body, the rotating shaft structure, and the second body; and
the rotating shaft structure further comprises a support door panel, fixedly connected to the rotating mechanism and rotating with rotation of the rotating mechanism, and the support door panel is configured to support the flexible screen.

8. The rotating shaft structure according to claim 7, wherein when the main swing arm comprises the first main swing member and the second main swing member, the first main swing member and the second main swing member each are provided with a fastening post, and the main swing arm is connected to the support door panel by using the fastening posts.

9. The rotating shaft structure according to claim 7, wherein a material of the support door panel comprises an ultra-high polymer material, and the support door panel is integrally formed.

10. The rotating shaft structure according to claim 1, wherein the rotating shaft structure further comprises a decorating door panel, fixedly connected to the rotating mechanism and rotating with rotation of the rotating mechanism, and the decorating door panel is configured to cover the rotating mechanism, the synchronization mechanism, and/or the damping mechanism.

11. The rotating shaft structure according to claim 10, wherein when the secondary swing arm comprises the swing arm rotating member and the sliding member, the decorating door panel is fixedly connected to a side of the sliding member facing away from the first protrusion, so that the decorating door panel is fixedly connected to the secondary swing arm; and
two opposite ends of the decorating door panel are partially bent, a decorating sliding groove is formed between a bent portion of the decorating door panel and an unbent portion of the decorating door panel, two opposite ends of the connecting member each are provided with a second protrusion, the second protrusion is located in the decorating sliding groove, and the decorating door panel is slidably connected to the connecting member through the decorating sliding groove.

12. The rotating shaft structure according to claim 10, wherein a material of the decorating door panel comprises an ultra-high polymer material, and the decorating door panel is integrally formed.

13. The rotating shaft structure according to claim 1, wherein there are two pin shafts, two concave gears, two first springs, and four damping swing arms;
the two pin shafts are arranged side by side along a first direction, the pin shaft extends along a second direction, the concave gear has two concave gear holes, the two concave gear holes are arranged side by side along the first direction, the concave gear is separately sleeved on the two pin shafts through the two concave gear holes, there is a gap between the two concave gears, the two first springs are respectively sleeved on the two pin shafts and are separately located in the gap between the two concave gears, the rotating cams of the two damping swing arms are disposed neighboring to one of the concave gears and are located on a side of the concave gear facing away from the first spring along the second direction, and the rotating cams of other two damping swing arms are disposed neighboring to the other concave gear and are located on a side of the concave gear facing away from the first spring along the second direction; and
two side walls of an end of the swinging member far away from the rotating cam are provided with a second protruding post, the connecting member is provided with a fifth connecting sliding groove adapted to the damping swing arm, a side wall of the fifth connecting sliding groove is partially recessed to form a second groove adapted to the second protruding post, and the second protruding post is slided and rotated in the second groove, so that the damping mechanism is slidably and rotatably connected to the connecting member, wherein
the first direction is a direction from the first body to the second body, and the second direction is an axial direction of the rotating shaft structure.

14. The rotating shaft structure according to claim 13, wherein a connection portion is disposed between two damping swing arms located on the same pin shaft, and two ends of the connection portion are respectively fixedly connected to the two damping swing arms.

15. The rotating shaft structure according to claim 1, wherein the smoothing swing arm comprises a rotating shaft and a sliding portion located on a side of the rotating shaft, the sliding portion is provided with a limiting block, and two side walls of an end of the sliding portion far away from the rotating shaft each are provided with a third protruding post;
the flexible beams are located on two sides of the connecting rod, and the connecting rod is provided with a limiting hole;
the shaft cover is provided with a rotating hole adapted to the rotating shaft, so that the smoothing swing arm is rotatably connected to the shaft cover; and the connecting member is provided with a fourth connecting sliding groove, a side wall of the fourth connecting sliding groove is partially recessed to form a third groove adapted to the third protruding post, and the third protruding post is slided and rotated in the third groove, so that the smoothing swing arm is slidably and rotatably connected to the connecting member; and
the flexible beams located on the two sides of the connecting rod are separately fastened to an unrecessed side wall of the fourth connecting sliding groove, and the limiting block of the smoothing swing arm is clamped in the limiting hole of the connecting rod, so that the smoothing swing arm is fixedly connected to the connecting rod.

16. The rotating shaft structure according to claim 2, wherein two side walls of the lateral swing arm each are provided with a second protruding strip, the connecting member is provided with a fifth connecting sliding groove, a side wall of the fifth connecting sliding groove is partially recessed to form a fourth groove adapted to the second protruding strips, and the second protruding strips are slided in the fourth groove, so that the lateral swing arm is slidably connected to the connecting member;
the shaft cover is provided with a third shaft cover sliding groove adapted to the lateral rotating portion, and the lateral member is rotatably connected to the shaft cover by using the lateral rotating portion;
there are two lateral rotating portions, the two lateral rotating portions are spaced away;
the lateral swing arm is an annular structure with an opening, and the two lateral rotating portions are separately fixedly connected to the lateral swing arm and are located on two sides of the opening; and
the support member is located in the annular structure, and the roller is located in a gap between the two lateral rotating portions.

17. The rotating shaft structure according to claim 1, wherein there are three damping mechanisms.

18. The rotating shaft structure according to claim 17, wherein the three damping mechanisms are all concave-convex gear damping mechanisms; or the three damping mechanisms are all smoothing damping mechanisms; or at least one of the three damping mechanisms is a concave-convex gear damping mechanism, and at least one of the three damping mechanisms is a smoothing damping mechanism.

19. The rotating shaft structure according to claim 2, wherein there are three damping mechanisms;
at least one of the three damping mechanisms is a concave-convex gear damping mechanism, and at least one of the three damping mechanisms is a lateral damping mechanism; or
at least one of the three damping mechanisms is a smoothing damping mechanism, and at least one of the three damping mechanisms is a lateral damping mechanism.

20. A foldable terminal, wherein the foldable terminal is an outward foldable terminal, and the outward foldable terminal comprises a first body, a second body, and a rotating shaft structure connecting the first body to the second body, wherein the rotating shaft structure comprises:
a shaft cover:
two connecting members, located on two sides of the shaft cover, and configured to respectively connect to the first body and the second body;
a rotating mechanism, rotatably connected to the shaft cover and slidably and rotatably connected to the connecting members, and configured to control movements of the connecting members;
a synchronization mechanism, rotatably connected to the shaft cover and slidably and rotatably connected to the connecting members, and configured to synchronize rotation of the two connecting members; and
a plurality of damping mechanisms, wherein the plurality of damping mechanisms comprise a concave-convex gear damping mechanism and/or a smoothing damping mechanism, wherein
the concave-convex gear damping mechanism comprises a pin shaft, a concave gear, a first spring, and at least two damping swing arms, the pin shaft is fixedly connected to the shaft cover, and the concave gear and the first spring are both sleeved on the pin shaft; the damping swing arm comprises a rotating cam sleeved on the pin shaft and neighboring to and in contact with the concave gear and a swinging member located on a side of the rotating cam, and the swinging members of the two damping swing arms are slidably and rotatably connected to the two connecting members; and when the swinging members and the connecting members are slided and rotated, the first spring is compressed and generates an axial squeezing force, applied between the concave gear and the rotating cam to generate a damping force; and
the smoothing damping mechanism comprises two smoothing members, the smoothing member comprises a smoothing swing arm and a flexible unit, the flexible units of the two smoothing members are respectively fastened to the two connecting members, ends of the smoothing swing arms are rotatably connected to the shaft cover, and other ends of the smoothing swing arms of the two smoothing members are respectively slidably and rotatably connected to the connecting members; the flexible unit comprises a connecting rod and a flexible beam, and the smoothing swing arm is fixedly connected to the connecting rod; and when the other end of the smoothing swing arm and the connecting member are slided and rotated, the connecting rod is driven to move, and the flexible beam is compressed to generate a damping force.
